(19) United States
(12) Patent Application Publication
(10) Pub. No.: US 2026/0125579 A1
(43) Pub. Date: May 7, 2026

(54) COMPOUND, COMPOSITION, SURFACE TREATMENT AGENT, ARTICLE AND METHOD FOR MANUFACTURING ARTICLE

(71) Applicant: AGC Inc., Tokyo (JP)

(72) Inventors: Koki WATANABE, Tokyo (JP); Shiori KAWAKAMI, Chiyoda-ku, Tokyo (JP); Daisuke KOBAYASHI, Tokyo (JP); Yoshihito TOKUNAGA, Tokyo (JP)

(73) Assignee: AGC Inc., Tokyo (JP)

(21) Appl. No.: 19/438,706

(22) Filed: Jan. 2, 2026

Related U.S. Application Data
(63) Continuation of application No. PCT/JP2024/024450, filed on Jul. 5, 2024.

(30) Foreign Application Priority Data
Jul. 5, 2023 (JP) 2023-110542

(51) Int. Cl. C09D 183/08; C07F 7/18; C08G 77/04; C08G 77/26; C08G 77/48; C09D 183/04; C09D 183/14

(52) U.S. Cl. CPC C09D 183/08; C07F 7/1804; C08G 77/04; C08G 77/26; C08G 77/485; C09D 183/04; C09D 183/14

(57) ABSTRACT

A new compound and a new composition useful as a surface treatment agent capable of forming a surface-treated layer having excellent abrasion resistance on a substrate are provided.

A compound represented by Formula (1-1) or Formula (1-2).

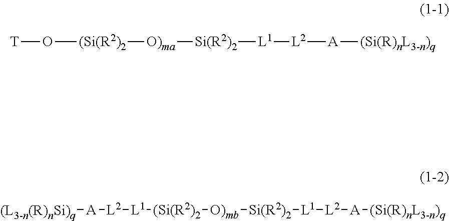

### INCORPORATION BY REFERENCE

This application is based upon and claims the benefit of priority from Japanese patent application No. 2023-110542, filed on Jul. 5, 2023, and PCT application No. PCT/JP2024/024450, filed on Jul. 5, 2024, the disclosure of which is incorporated herein in its entirety by reference.

### BACKGROUND

The present disclosure relates to a compound, a composition, a surface treatment agent, an article, and a method for manufacturing an article.

In recent years, there has been a demand for a technique for preventing the surface of an article from being stained with fingerprints, and a technique for facilitating the removal of dirt in order to improve properties of the article such as its appearance and visibility. As a specific method, a method for treating the surface of an article by using a surface treatment agent is known.

For example, Patent Literature 1 discloses a silane compound having a specific siloxane group used in such a surface treatment agent.
Patent Literature 1: International Patent Publication No. WO2023/017830

### SUMMARY

However, when we formed a surface-treated layer by using the silane compound disclosed in Patent Literature 1, we have found that it is necessary to further improve its abrasion resistance.

The present disclosure has been made in view of the above-described circumstances, and a problem to be solved by an embodiment according to the present invention is to provide a new compound and a new composition useful as a surface treatment agent capable of forming a surface-treated layer having excellent abrasion resistance on a substrate.

Another problem to be solved by an embodiment according to the present invention is to provide a surface treatment agent capable of forming a surface-treated layer having excellent abrasion resistance on a substrate.

Another problem to be solved by an embodiment according to the present invention is to provide an article including a surface-treated layer having excellent abrasion resistance and a method for manufacturing such an article.

The present disclosure includes the below-shown aspects.

[1]

A compound represented by below-shown Formula (1-1) or Formula (1-2).

[2]

The compound according to Item [1], wherein a group represented by -A-(Si(R)ₙL₃₋ₙ)_{q} in Formula (1-1) and Formula (1-2) is a group represented by below-shown Formula (3-1A).

[3]

The compound according to Item [1] or [2], wherein L¹ is a single bond or an alkylene group.

[4]

The compound according to any one of Items [1] to [3], wherein L¹ is a single bond.

[5]

The compound according to any one of Items [1] to [4], wherein ma and mb are each independently a number of 2 to 600.

[6]

The compound according to any one of Items [1] to [5], wherein q is an integer of 1 to 4.

[7]

A composition comprising a compound according to any one of Items [1] to [6] and a liquid medium.

[8]

A surface treatment agent comprising a compound according to any one of Items [1] to [6].

[9]

A surface treatment agent comprising a compound according to any one of Items [1] to [6] and a liquid medium.

[10]

A method for manufacturing an article including a surface-treated layer formed on a substrate by performing a surface treatment on the substrate by using the surface treatment agent according to Item [8].

[11]

An article comprising a substrate, and a surface-treated layer disposed on the substrate, a surface of the surface-treated layer being treated with the surface treatment agent according to Item [8].

[12]

The article according to Item [11], wherein the article is an optical member.

[13]

The article according to Item [11], wherein the article is a display or a touch panel.

[14]

A method for manufacturing an article including a surface-treated layer formed on a substrate by performing a surface treatment on the substrate by using the surface treatment agent according to Item [9].

[15]

An article comprising a substrate, and a surface-treated layer disposed on the substrate, a surface of the surface-treated layer being treated with the surface treatment agent according to Item [9].

[16]

The article according to Item [15], wherein the article is an optical member.

[17]

The article according to Item [15], wherein the article is a display or a touch panel.

According to an embodiment of the present invention, it is possible to provide a new compound and a new composition useful as a surface treatment agent capable of forming a surface-treated layer having excellent abrasion resistance on a substrate.

According to an embodiment of the present invention, it is possible to provide a surface treatment agent capable of forming a surface-treated layer having excellent abrasion resistance on a substrate.

According to an embodiment of the present invention, it is possible to provide an article including a surface-treated layer having excellent abrasion resistance and a method for manufacturing such an article.

The above and other objects, features and advantages of the present disclosure will become more fully understood from the detailed description given hereinbelow.

### DESCRIPTION OF EMBODIMENTS

A numerical value range specified by using “-” in the specification of the present disclosure includes numerical values before and after “-” as a lower limit value and an upper limit value, respectively, of the range.

In numerical ranges described in a stepwise manner in the present specification, the upper or lower limit value of one numerical range may be replaced with the upper or lower limit value of another numerical range described in a stepwise manner. Further, in numerical ranges described in a stepwise manner in the present specification, the upper or lower limit value of a numerical range may be replaced with values shown in Examples.

In the specification of the present disclosure, the “surface-treated layer” refers to a layer that is formed on the surface of a substrate by a surface treatment.

In this specification, when a compound or a group is represented by a specific formula (X), the compound or the group represented by this formula (X) may be expressed as a compound (X) or a compound X, and a group (X) or a group X, respectively.

In this specification, a methyl group may be represented by “Me”, and an ethyl group may be represented by “Et”.

The bonding direction of a divalent group shown in the specification of the present disclosure is not limited to any particular directions unless otherwise specified. For example, when Y is —COO— in a compound represented by a formula “X—Y—Z”, Y may be —CO—O— or —O—CO—. Further, the aforementioned compound may be “X—CO—O—Z” or “X—O—CO—Z”.

### [Compound]

A compound according to the present disclosure is a compound represented by Formula (1-1) (which will be described later) or a compound represented by Formula (1-2) (which will be described later). In this specification, the compound according to the present disclosure means at least one of a compound represented by Formula (1-1) and a compound represented by Formula (1-2).

When a compound according to the present disclosure is used, a surface-treated layer having excellent abrasion resistance can be formed. Although the reason for this feature is not clear, it is presumed as follows.

It is presumed that in the compound according to the present disclosure, by having a group represented by L² at a specific place, when its abrasion resistance is evaluated, a group represented by L² has relatively high binding energy, so that the bond is less likely to be disengaged, and hence a surface-treated layer having excellent abrasion resistance can be formed.

A compound according to the present disclosure will be described hereinafter in detail.

<Compound represented by Formula (1-1)>

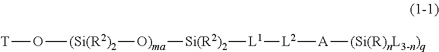

In Formula (1-1),
T is (R¹)₃Si—, a monovalent cyclic polysiloxane residue, or a monovalent cage-like polysiloxane residue,
R¹ is each independently a hydrocarbon group or a trialkylsilyloxy group,
R² is each independently a hydrocarbon group,
L¹ is a single bond or a divalent linking group,
L² is —CH═CH—, —C≡C—, or —C(═CH₂)—,
A is a single bond or a linking group having a valence of (q+1),
R is each independently a hydrocarbon group,
L is each independently a hydrolyzable group, a group having a hydrolyzable group, or a hydroxyl group,
ma is a number of 0 or greater,
mb is a number of 1 or greater,
n is each independently an integer of 0 to 2, and
q is each independently an integer of 1 or greater.

In Formula (1-1), T is (R¹)₃Si—, a monovalent cyclic polysiloxane residue, or a monovalent cage-like polysiloxane residue.

Examples of the hydrocarbon group represented by R¹ include an aliphatic hydrocarbon group and an aromatic hydrocarbon group. In particular, the hydrocarbon group is preferably an aliphatic hydrocarbon group and more preferably an alkyl group. The alkyl group may be any of a linear alkyl group, a branched alkyl group, or a cyclic alkyl group, and is preferably a linear alkyl group. The number of carbon atoms of the alkyl group is preferably 1 to 10, more preferably 1 to 6, and still more preferably 1 to 4. The hydrocarbon group represented by R¹ is more preferably a methyl group, an ethyl group, an n-propyl group, or an n-butyl group, and more preferably a methyl group.

The alkyl group contained in the trialkylsilyloxy group represented by R¹ may be any of a linear alkyl group, a branched alkyl group, or a cyclic alkyl group, and is preferably a linear alkyl group. The number of carbon atoms of the alkyl group contained in the trialkylsilyloxy group represented by R¹ is preferably 1 to 10, more preferably 1 to 6, and still more preferably 1 to 4. The alkyl group contained in the trialkylsilyloxy group represented by R¹ is more preferably a methyl group, an ethyl group, an n-propyl group, or an n-butyl group, and still more preferably a methyl group.

The plurality of R¹ may be the same as each other or different from each other, and are preferably the same as each other in view of the ease of the manufacturing.

Examples of the group represented by (R¹)₃Si— include a methyldiethylsilyl group, a methylethylpropylsilyl group, a methylethylbutylsilyl group, a methyldipropylsilyl group, a methylpropylbutylsilyl group, a methyldibutylsilyl group, a dimethylethylsilyl group, a dimethylpropylsilyl group, a dimethylbutylsilyl group, a trimethylsilyl group, a triethylsilyl group, a tri-n-propylsilyl group, a tri-isopropylsilyl group, and a trialkylsilyloxy group having these groups.

Among them, in order to improve the water repellency of the surface-treated layer, R¹ is preferably a linear alkyl group, more preferably a methyl group, an ethyl group, an n-propyl group, or an n-butyl group, and still more preferably a methyl group.

The monovalent cyclic polysiloxane residue is preferably a group represented by Formula (T1).

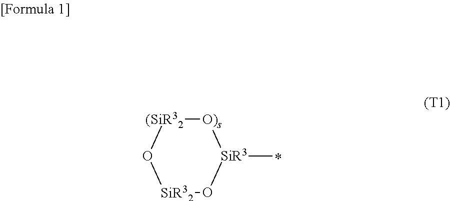

In Formula (T1):
R³ is each independently a hydrocarbon group, a hydrocarbon group having a substituent, or a group represented by —O—SiR⁵¹₃,
s is an integer of 1 to 4,
R⁵¹ is each independently a hydrocarbon group or a trialkylsilyloxy group, and
* indicates a bonding position.

Examples of the hydrocarbon group represented by R³ include an aliphatic hydrocarbon group and an aromatic hydrocarbon group. In particular, the hydrocarbon group is preferably an aliphatic hydrocarbon group and more preferably an alkyl group.

The alkyl group in an aspect of the hydrocarbon group represented by R³ may be any of a linear alkyl group, a branched alkyl group, or a cyclic alkyl group, and is preferably a linear alkyl group. The number of carbon atoms of the alkyl group is preferably 1 to 10, more preferably 1 to 8, and still more preferably 1 to 4. Specifically, the alkyl group represented by R³ is preferably a methyl group, an ethyl group, an n-propyl group, an n-butyl group, an isobutyl group, or a heptyl group, and more preferably a methyl group.

Examples of the hydrocarbon group contained in the hydrocarbon group having a substituent represented by R³ include an aliphatic hydrocarbon group and an aromatic hydrocarbon group. In particular, the hydrocarbon group is preferably an aliphatic hydrocarbon group and more preferably an alkyl group. The alkyl group may be any of a linear alkyl group, a branched alkyl group, or a cyclic alkyl group, and is preferably a linear alkyl group. The number of carbon atoms of the alkyl group contained in the substitution alkyl group is preferably 1 to 10, more preferably 1 to 8, and still more preferably 2 to 4.

Examples of the substituent in the hydrocarbon group having the substituent represented by R³ include a halogen atom, a hydroxyl group, an alkoxy group, a trialkylsilyl ether group, a trialkylsilyl group, an amino group, a nitro group, a cyano group, a sulfonyl group, a trifluoromethyl group, and a group represented by —SiR⁵²₃. R⁵² is each independently a hydrocarbon group or a trialkylsilyloxy group.

Examples of the hydrocarbon group represented by R⁵² include hydrocarbon groups similar to those represented by R³.

The alkyl group contained in the trialkylsilyloxy group represented by R⁵² may be any of a linear alkyl group, a branched alkyl group, or a cyclic alkyl group, and is preferably a linear alkyl group. The number of carbon atoms of the alkyl group is preferably 1 to 10, more preferably 1 to 8, still more preferably 1 to 4, and particularly preferably 1. The three alkyl groups contained in the trialkylsilyloxy group may be the same as each other or different from each other.

The three R⁵² may be the same as each other or different from each other, and are preferably the same as each other in view of the ease of the manufacturing.

When R³ is a group represented by —O—SiR⁵¹₃, R⁵¹ is each independently a hydrocarbon group or a trialkylsilyloxy group. Examples of the hydrocarbon group represented by R⁵¹ include hydrocarbon groups similar to those represented by R³. Examples of the trialkylsilyloxy group represented by R⁵¹ include trialkylsilyloxy group similar to those represented by R⁵².

The plurality of R³ may be the same as each other or different from each other, and are preferably the same as each other in view of the ease of the manufacturing.

Examples of monovalent cyclic polysiloxane residues include groups shown below. * indicates a bonding position.

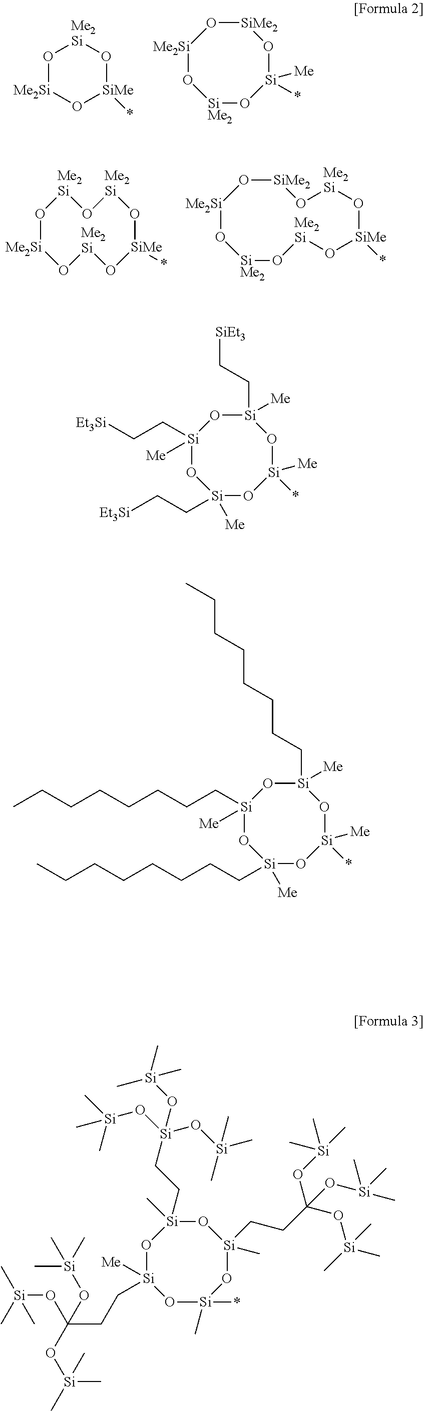

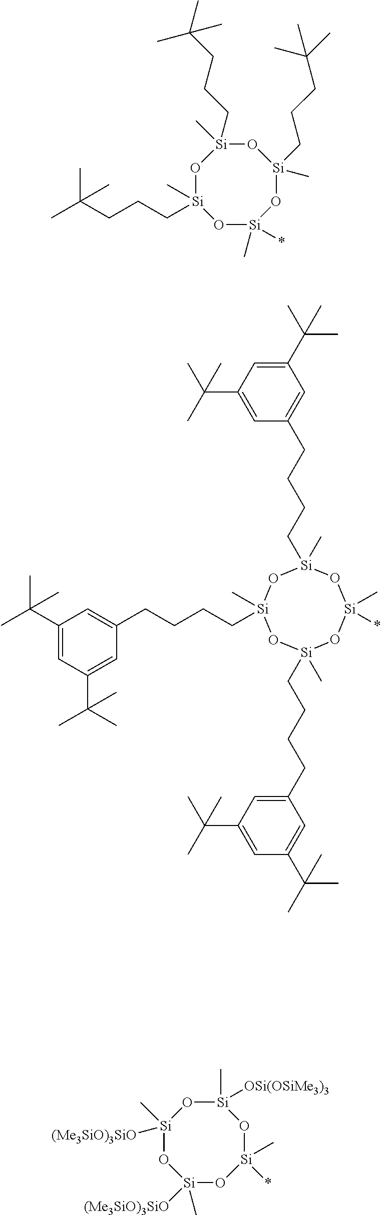

The monovalent cage-like polysiloxane residue is preferably a group represented by Formula (T2).

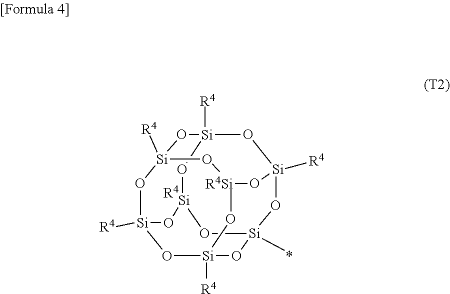

In Formula (T2),
R⁴ is each independently a hydrocarbon group or a trialkylsilyloxy group, and
* indicates a bonding position.

Examples of the hydrocarbon group represented by R⁴ include an aliphatic hydrocarbon group and an aromatic hydrocarbon group. In particular, the hydrocarbon group is preferably an aliphatic hydrocarbon group and more preferably an alkyl group. The alkyl group may be any of a linear alkyl group, a branched alkyl group, or a cyclic alkyl group, and is preferably a linear alkyl group or a branched alkyl group. The number of carbon atoms of the alkyl group is preferably 1 to 10, more preferably 1 to 6, and still more preferably 1 to 4. The hydrocarbon group represented by R⁴ is more preferably a methyl group, an ethyl group, an n-propyl group, an n-butyl group, or an isobutyl group, and still more preferably an isobutyl group.

The alkyl group contained in the trialkylsilyloxy group represented by R⁴ may be any of a linear alkyl group, a branched alkyl group, or a cyclic alkyl group, and is preferably a linear alkyl group. The number of carbon atoms of the alkyl group contained in the trialkylsilyloxy group represented by R⁴ is preferably 1 to 10, more preferably 1 to 6, and still more preferably 1 to 4. The hydrocarbon group represented by R¹ is more preferably a methyl group, an ethyl group, an n-propyl group, or an n-butyl group, and still more preferably a methyl group.

The plurality of R⁴ may be the same as each other or different from each other, and are preferably the same as each other in view of the ease of the manufacturing.

Examples of the monovalent cage-like polysiloxane residue include groups shown below. * indicates a bonding position.

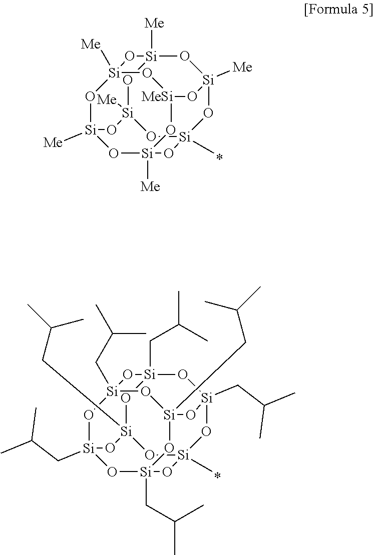

In Formula (1-1), R² is each independently a hydrocarbon group.

Examples of R² include the hydrocarbon group represented by R¹. In particular, the hydrocarbon group is preferably an aliphatic hydrocarbon group and more preferably an alkyl group. The alkyl group may be any of a linear alkyl group, a branched alkyl group, or a cyclic alkyl group, and is preferably a linear alkyl group. The number of carbon atoms of the alkyl group is preferably 1 to 10, more preferably 1 to 6, and still more preferably 1 to 4. R² is more preferably a methyl group, an ethyl group, an n-propyl group, or an n-butyl group, and still more preferably a methyl group.

The number of carbon atoms of R² is preferably 1 to 10, more preferably 1 to 6, and still more preferably 1 to 4.

In Formula (1-1), L¹ is a single bond or a divalent linking group.

Examples of divalent linking groups include a divalent hydrocarbon group, a divalent heterocyclic group, —O—, —S—, —SO₂—, —N(R^{d})—, —C(O)—, —Si(R^{a})₂—, and groups obtained by combining two or more of these groups.

The aforementioned divalent hydrocarbon group may be a divalent saturated hydrocarbon group or a divalent aromatic hydrocarbon group. The divalent saturated hydrocarbon group may be a linear chain, a branched chain, or a ring, and examples include an alkylene group. The number of carbon atoms of the alkylene group is preferably 1 to 30, more preferably 1 to 20, still more preferably 4 to 20, and particularly preferably 5 to 15. The divalent aromatic hydrocarbon group is preferably a divalent aromatic hydrocarbon group having a number of carbon atoms of 5 to 20, for example, a phenylene group.

L¹ is preferably a single bond or a divalent saturated hydrocarbon group, more preferably a single bond or an alkylene group, and still more preferably a single bond or an alkylene group having a number of carbon atoms of 3 to 15 because the abrasion resistance becomes more excellent.

In Formula (1-1), L² is —CH═CH—, —C≡C—, or —C(═CH₂)—.

L² is preferably —CH═CH— or —C≡C— because the abrasion resistance becomes more excellent.

In Formula (1-1), R is each independently a hydrocarbon group.

Examples of the hydrocarbon group represented by R include the hydrocarbon group represented by R¹.

In Formula (1-1), L is each independently a hydrolyzable group, a group having a hydrolyzable group, or a hydroxyl group.

The hydrolyzable group is a group which becomes a hydroxyl group through a hydrolysis reaction. That is, a hydrolyzable silyl group represented by Si-L becomes a silanol group represented by Si—OH through a hydrolysis reaction. Such silanol groups further react with each other and form a Si—O—Si bond. Further, such a silanol group has a dehydration condensation reaction with a silanol group derived from an oxide present on the surface of the substrate, and thereby can form a Si—O—Si bond.

Examples of hydrolyzable groups include an alkoxy group, an aryloxy group, a halogen atom, an acyl group, an acyloxy group, and an isocyanato group (—NCO). The alkoxy group is preferably an alkoxy group having a number of carbon atoms of 1 to 4. The aryloxy group is preferably an aryloxy group having a number of carbon atoms of 3 to 10. Note that the aryl group of the aryloxy group includes a heteroaryl group. The halogen atom is preferably a chlorine atom. The acyl group is preferably an acyl group having a number of carbon atoms of 1 to 6. The acyloxy group is preferably an acyloxy group having a number of carbon atoms of 1 to 6.

The group having a hydrolyzable group may be, for example, the group having a hydrolyzable group shown above as an example. The group having a hydrolyzable group is preferably —O-L^{A}-L^{B}. L^{A} is an alkylene group which may have an etheric oxygen atom, and L^{B} is a hydrolyzable group.

The number of carbon atoms of the alkylene group is preferably 1 to 10.

The aforementioned alkylene group represented by L^{A} may have an etheric oxygen atom between carbon atoms. The number of etheric oxygen atoms in the aforementioned alkylene group may be 1 or 2 or greater. When L^{A} is an alkylene group having an etheric oxygen atom, the atom bonded to the —O— side in —O-L^{A}-L^{B} is preferably a carbon atom constituting the alkylene group having the etheric oxygen atom.

The hydrolyzable group represented by L^{B} is synonymous with the above-described hydrolyzable group represented by L, and its preferred forms are also the same as those described above.

In particular, L is preferably an alkoxy group having a number of carbon atoms of 1 to 4 or a halogen atom in view of the ease of the manufacturing of the compound. L is preferably an alkoxy group having a number of carbon atoms of 1 to 4 and more preferably an ethoxy group or a methoxy group in view of the fact that outgassing during the application is small and because the storage stability of the compound becomes more excellent.

In Formula (1-1), ma is a number of 0 or greater.

Note that when T is (R¹)₃Si— in which all of R¹ are trialkylsilyloxy groups, ma is preferably a number of 0 or greater. Further, when T is (R¹)₃Si— in which at least one of R¹ is a hydrocarbon group, a monovalent cyclic polysiloxane residue, or a monovalent cage-like polysiloxane residue, ma is preferably a number of 1 or greater.

ma is preferably a number of 2 to 600, more preferably a number of 3 to 500, still more preferably a number of 9 to 50, particularly preferably a number of 11 to 30, and most preferably a number of 11 to 25.

In Formula (1-1), n is each independently an integer of 0 to 2.

n is preferably 0 or 1 and more preferably 0. The presence of a plurality of L makes the adhesive property of the surface-treated layer for the substrate stronger.

When n is 1 or less, the plurality of L present in one molecule may be the same as each other or different from each other. The plurality of L are preferably the same as each other in view of the availability of raw materials and the ease of the manufacturing of the compound. When n is 2, the plurality of R present in one molecule may be the same as each other or different from each other. The plurality of R are preferably the same as each other in view of the availability of raw materials and the ease of the manufacturing of the compound.

In Formula (1-1), q is an integer of 1 or greater.

q is preferably an integer of 1 to 15, more preferably an integer of 1 to 6, still more preferably an integer of 1 to 4, and particularly preferably 2 or 3 because the abrasion resistance of the surface-treated layer becomes more excellent.

q may be 1. When q is an integer of 2 or greater, the plurality of [Si(R)ₙL₃₋ₙ] may be the same as each other or different from each other.

In Formula (1-1), A is a single bond or a linking group having a valence of (q+1).

A may be any group that does not impair the effects of the present disclosure, and examples include an alkylene group which may have an etheric oxygen atom or a divalent organopolysiloxane residue, a carbon atom, a nitrogen atom, a silicon atom, an organopolysiloxane residue having a valence of 2 to 8, and groups obtained by removing Si(R)ₙL₃₋ₙ from Formulas (3-1A), (3-1B), and (3-1A-1) to (3-1A-7) (which will be described later).

Further, A may be any of groups (g2-1) to (g2-14) (which will be described later).

The group represented by -A(Si(R)ₙL₃₋ₙ)_{q} in Formula (1-1) is preferably a group (3-1A) or a group (3-1B), and more preferably a group (3-1A).

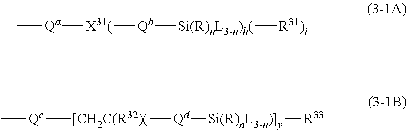

Note that in Formulas (3-1 A) and (3-1B), the definitions of R, L, and n are the same as those described above.

In Formula (3-1A), Q^{a} is a single bond or a divalent linking group.

Examples of divalent linking groups include a divalent hydrocarbon group, a divalent heterocyclic group, —O—, —S—, —SO₂—, —N(R^{d})—, —C(O)—, —Si(R^{a})₂—, and groups obtained by combining two or more of these groups. The aforementioned divalent hydrocarbon group may be a divalent saturated hydrocarbon group or a divalent aromatic hydrocarbon group.

The divalent saturated hydrocarbon group may be a linear chain, a branched chain, or a ring, and examples include an alkylene group. The number of carbon atoms of the alkylene group is preferably 1 to 30, more preferably 1 to 20, still more preferably 4 to 20, and particularly preferably 5 to 15. Further, the divalent aromatic hydrocarbon group is preferably one having a number of carbon atoms of 5 to 20, and examples include a phenylene group.

The aforementioned R^{a} is an alkyl group (preferably one having a number of carbon atoms of 1 to 10) or a phenyl group. The aforementioned R^{d} is a hydrogen atom or an alkyl group (preferably one having a number of carbon atoms of 1 to 10).

Note that examples of groups obtained by combining two or more of the aforementioned groups include alkylene groups having —C(O)O—, —C(O)S—, —C(O)N(R^{d})—, —N(R^{d})C(O)N(R^{d})—, —N(R^{d})C(O)O—, or —SO₂N(R^{d})—, an alkylene group having —C(O)N(R^{d})—, an alkylene group having —OC(O)N(R^{d})—,an alkylene group having an etheric oxygen atom, an alkylene group having —S—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, and an alkylene group having —Si(R^{a})₂-phenylene group-Si(R^{a})₂.

In particular, Q^{a} is preferably a divalent hydrocarbon group (preferably an alkylene group), a divalent heterocyclic group, alkylene groups having —O—, —S—, —SO₂—, —N(R^{d})—, —C(O)—, —Si(R^{a})₂—, —C(O)O—, —C(O)S—, —C(O)N(R^{d})—, —N(R^{d})C(O)N(R^{d})—, or —N(R^{d})C(O)O—, an alkylene group having —SO₂N(R^{d})—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—, more preferably an alkylene group having —C(O)O— or —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, or an alkylene group having —N(R^{d})C(O)N(R^{d})—, and still more preferably an alkylene group having —C(O)O— or an alkylene group having —C(O)N(R^{d})—.

Further, Q^{a} is preferably a divalent hydrocarbon group, a divalent heterocyclic group, alkylene groups having —SO₂—, —C(O)—, —Si(R^{a})₂—, —C(O)O—, —C(O)S—, —C(O)N(R^{d})—, —SO₂N(R^{d})—, or —C(O)N(R^{d})—, an alkylene group having —C(O)O—, an alkylene group having —SO₂N(R^{d})—, or an alkylene group —Si(R^{a})₂-phenylene group —Si(R^{a})₂, and more preferably —C(O)—. The definitions of R^{a} and R^{d} are the same as those described above.

In Formula (3-1A), X³¹ is a group having a single bond, an alkylene group, a nitrogen atom, a carbon atom, a silicon atom, an organopolysiloxane residue having a valence of 2 to 8, or a group having a ring having a valence of (h+i+1).

Note that the aforementioned alkylene group may have —O—, a silphenylene skeleton group, a divalent organopolysiloxane residue, or a dialkylsilylene group. The alkylene group may have a plurality of groups selected from the group consisting of —O—, a silphenylene skeleton group, a divalent organopolysiloxane residue, and a dialkylsilylene group.

The number of carbon atoms of the alkylene group represented by X³¹ may be 1 to 60, 1 to 30, 1 to 20, or 1 to 10.

Examples of organopolysiloxane residues having a valence of 2 to 8 include a divalent organopolysiloxane residue and an organopolysiloxane residue having a valence of (w+1) (which will be described later).

In Formula (3-1A), when X³¹ is a group having a ring having a valence of (h+i+1), Q^{a}, (-Q^{b}-Si(R)ₙL₃₋ₙ), and R³¹ are directly bonded to atoms constituting this ring. However, this ring is a ring other than the organopolysiloxane ring.

The ring in X³¹ may be any of a monocyclic ring, a condensed polycyclic ring, a bridged ring, a spiro ring, and an assembled polycyclic ring, and the atoms constituting the ring may be a carbon ring consisting solely of carbon atoms or a heterocyclic ring consisting of heteroatoms having a valence of 2 or greater and carbon atoms. Further, the bond between the atoms constituting the ring may be a single bond or multiple bonds. Further, the ring may be an aromatic ring or a non-aromatic ring.

The monocyclic ring is preferably a 4 to 8 membered ring, and more preferably a 5 membered ring or a 6 membered ring. The condensed polycyclic ring is preferably a condensed polycyclic ring in which two or more 4 to 8 membered rings are condensed, more preferably a condensed polycyclic ring in which 2 or 3 rings each selected from a 5 membered ring and a 6 membered ring are bonded, and still more preferably a condensed polycyclic ring in which one or two rings each selected from a 5 membered ring and a 6 membered ring and one 4 membered ring are bonded. The bridged ring is preferably a bridged ring in which a 5 membered ring or a 6 membered ring is the largest ring, and the spiro ring is preferably a spiro ring consisting of two 4 to 6 membered rings. The assembled polycyclic ring is preferably an assembled polycyclic ring in which 2 or 3 rings each selected from a 5 membered ring and a 6 membered ring are bonded through a single bond, through one to three carbon atoms, or through one heteroatom having a valence of 2 or 3. Note that in the assembled polycyclic ring, one of Q^{a}, (-Q^{b}-Si(R)ₙL₃₋ₙ), and R³¹ (when i=1 or greater) is preferably bonded to each ring.

The heteroatoms constituting the aforementioned ring are preferably nitrogen atoms, oxygen atoms, and sulfur atoms, and more preferably nitrogen atoms and oxygen atoms. The number of heteroatoms constituting the ring is preferably three or less. Further, when the number of heteroatoms constituting the ring is 2 or greater, these heteroatoms may be different from one another.

The ring in X³¹ is preferably one ring selected from the group consisting of a 3 to 8 membered aliphatic ring, a benzene ring, a 3 to 8 membered heterocyclic ring, a condensed ring in which 2 or 3 of these rings are condensed, a bridged ring in which a 5 membered ring or a 6 membered ring is the largest ring, and an assembled polycyclic ring having two or more of these rings in which an alkylene group having a number of carbon atoms of 3 or less of which the linking group is a single bond, an oxygen atom, or a sulfur atom in view of the ease of the manufacturing of the compound and because the abrasion resistance of the surface-treated layer becomes more excellent.

Preferred rings are a benzene ring, a 5 or 6 membered aliphatic ring, a 5 or 6 membered heterocyclic ring having a nitrogen atom or an oxygen atom, and a condensed ring consisting of a 5 or 6 membered carbon ring and a 4 to 6 membered heterocyclic ring.

Examples of the ring in X³¹ include the below-shown rings, a 1,3-cyclohexadiene ring, a 1,4-cyclohexadiene ring, an anthracene ring, a cyclopropane ring, a decahydronaphthalene ring, a norbornene ring, a norbornadiene ring, a furan ring, a pyrrole ring, a thiophene ring, a pyrazine ring, a morpholine ring, an aziridine ring, an isoquinoline ring, an oxazole ring, an isoxazole ring, a thiazole ring, an imidazole ring, a pyrazole ring, a pyran ring, a pyridazine ring, a pyrimidine ring, and an indene ring. Note that rings having an oxo group (═O) are also shown below.

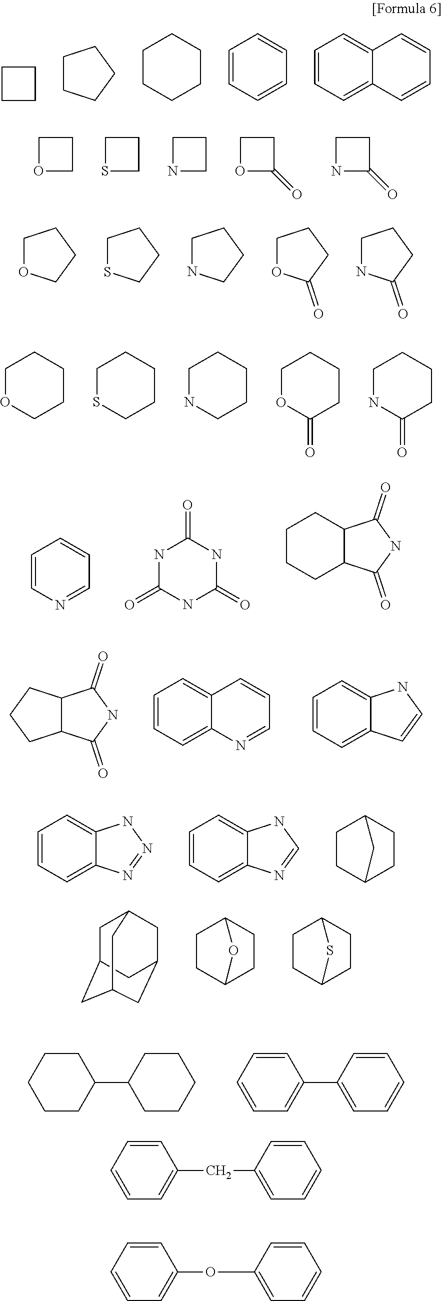

The bond that does not constitute the ring of atoms constituting the ring in X³¹ is a bond that is bonded to Q^{a}, (-Q^{b}-Si(R)ₙL₃₋ₙ), or R³¹. When there is a remaining bond(s), the remaining bond(s) is bonded to a hydrogen atom or a substituent. Examples of such substituents include a halogen atom, an alkyl group (which may contain an etheric oxygen atom between carbon atoms), a cycloalkyl group, an alkenyl group, an allyl group, an alkoxy group, and an oxo group (═O). Further, when one of carbon atoms constituting the ring (hereinafter also referred to as ring constituent carbon atoms) has two bonds bonded to Q^{a}, (-Q^{b}-Si(R)ₙL₃₋ₙ), or R³¹, Q^{a} and (-Q^{b}-Si(R)ₙL₃₋ₙ) may be bonded to this one carbon atom, or two (-Q^{b}-Si(R)ₙL₃₋ₙ) may be bonded to this one carbon atom. Q^{a} and (-Q^{b}-Si(R)ₙL₃₋ₙ) or R³¹ are preferably bonded to ring constituent atoms different from each other. Each of h (-Q^{b}-Si(R)ₙL₃₋ₙ) (i.e., h units each represented by -Q^{b}-Si(R)ₙL₃₋ₙ) may be bonded to ring constituent atoms different from each other, or two of them may be bonded to one of the ring constituent carbon atoms. Alternatively, there may be two or more ring constituent carbon atoms to which two (-Q^{b}-Si(R)ₙL₃₋ₙ) are bonded. i R³¹ (i.e., i units each represented by R³¹) may be bonded to ring constituent atoms different from each other, or two of them may be bonded to one ring constituent carbon atom. Alternatively, there may be two or more ring constituent carbon atoms to which two R³¹ are bonded.

In particular, X³¹ is preferably a nitrogen atom, a carbon atom, a silicon atom, an organopolysiloxane residue having a valence of 4 to 8, or a group having a ring having a valence of (h+i+1), and more preferably a carbon atom in order to improve the abrasion resistance of the surface-treated layer.

In Formula (3-1A), Q^{b} is a single bond or a divalent linking group.

The definition of the divalent linking group is synonymous with the above-described definition of Q^{a}.

In particular, Q^{b} is preferably an alkylene group which may have an etheric oxygen atom. The number of carbon atoms of the alkylene group is preferably 1 to 30, more preferably 1 to 20, still more preferably 2 to 20, and may be 2 to 10, 2 to 6, or 2 to 5. For example, the number of carbon atoms is 2, 3, 8, 9 or 11. Further, the aforementioned number of carbon atoms may be 1 to 10.

In Formula (3-1A), R³¹ is a hydrogen atom, a hydroxyl group, or an alkyl group.

The alkyl group may be any of a linear chain, a branched chain, and a ring, and is preferably a linear chain.

The number of carbon atoms of the alkyl group is preferably 1 to 5, more preferably 1 to 3, and still more preferably 1.

When X³¹ is a single bond or an alkylene group, h is 1 and i is 0,
when X³¹ is a nitrogen atom, h is an integer of 1 or 2 and i is an integer of 0 or 1, where h+i=2,
when X³¹ is a carbon atom or a silicon atom, h is an integer of 1 to 3 and i is an integer of 0 to 2, where h+i=3, and
when X³¹ is an organopolysiloxane residue having a valence of 2 to 8, h is an integer of 1 to 7 and i is an integer of 0 to 6, where h+i=1 to 7.

When X³¹ is a group having a ring having a valence of (h+i+1), h is an integer of 1 to 7 and i is an integer of 0 to 6, where h+i=1 to 7.

When there are two or more (-Q^{b}-Si(R)ₙL₃₋ₙ), the two or more (-Q^{b}-Si(R)ₙL₃₋ₙ) may be the same as each other or different from each other.

When there are two or more R³¹, the two or more (—R³¹) may be the same as each other or different from each other.

In particular, i is preferably 0 in order to improve the abrasion resistance of the surface-treated layer.

In Formula (3-1A), when Q^{a}, X³¹, and Q^{b} are single bonds, [Si(R)ₙL₃₋ₙ] is directly bonded to L².

In Formula (3-1B), Q^{c} is a single bond or a divalent linking group.

The definition of the divalent linking group is synonymous with the above-described definition of Q^{a}.

In Formula (3-1B), R³² is a hydrogen atom or an alkyl group having a number of carbon atoms of 1 to 10, and is preferably a hydrogen atom in view of the ease of the manufacturing of the compound.

The alkyl group is preferably a methyl group.

In Formula (3-1B), Q^{d} is a single bond or an alkylene group. The number of carbon atoms of the alkylene group is preferably 1 to 10 and more preferably 1 to 6. In view of the ease of the manufacturing of the compound, Q^{d} is preferably a single bond or CH₂—.

In Formula (3-1B), R³³ is a hydrogen atom or a halogen atom, and is preferably a hydrogen atom in view of the ease of the manufacturing of the compound.

y is an integer of 1 to 10, and preferably an integer of 1 to 6.

The two or more [CH₂C(R³²)(-Q^{d}-Si(R)ₙL₃₋ₙ)] may be the same as each other or different from each other.

The group (3-1A) is preferably one of groups (3-1A-1) to (3-1A-7).

-L³-(X³²)ₛ₁-Q^{b1}-Si(R)ₙL₃₋ₙ (3-1A-1)

-L³-(X³³)ₛ₂-Q^{a2}-N[-Q^{b2}-Si(R)ₙL₃₋ₙ]₂ (3-1A-2)

-Q^{a3}-Si(R^{g})[-Q^{b3}-Si(R)ₙL₃₋ₙ]₂ (3-1A-3)

-L³-[Q^{e}]ₛ₄-Q^{a4}-(O)ₜ₄₋C[—(O)ᵤ₄-Q^{b4}-Si(R)ₙL₃₋ₙ]_{3-w1}(—R³¹)_{w1} (3-1A-4)

-Q^{a5}Si[Q^{b5}Si(R)ₙL₃₋ₙ]₃ (3-1A-5)

-L³-[Q^{e}]ᵥ-Q^{a6}-Z^{c}[-Q^{b6}-Si(R)ₙL₃₋ₙ]_{w2} (3-1A-6)

-L³-[Q^{e}]ₛ₄-Q^{a4}-(O)ₜ₄₋Z^{c}[—(O-Q^{b4})ᵤ₄-Si(R)ₙL₃₋ₙ]_{w3}(—OH)_{w4} (3-1A-7)

Note that in Formulas (3-1A-1) to (3-1A-7), the definitions of R, L, and n are the same as those described above.

In particular, the group (3-1A) is preferably the group (3-1A-1) or the group (3-1A-4), and more preferably the group (3-1A-4).

In Formulas (3-1A-1) to (3-1A-2) and (3-1A-4) to (3-1A-7), L³ is a single bond or an alkylene group.

The aforementioned alkylene group is, for example, synonymous with the alkylene group shown above as an example of the divalent linking group represented by Q^{a}, and its preferred forms are also the same as those described above.

In the group (3-1A-1), X³² is —O—, —S—, —N(R^{d})—, —C(O)—, —C(O)O—, —C(O)S—, —SO₂N(R^{d})—, —N(R^{d})C(O)N(R^{d})—, —OC(O)N(R^{d})—, or —C(O)N(R^{d})— (note that N in the formula is bonded to Q^{b1}).

The definition of R^{d} is the same as that described above.

s1 is 0 or 1.

In particular, X³² is preferably —O—, —S—, —N(R^{d})—, —C(O)—, —C(O)O—, —C(O)S—, —SO₂ N(R^{d})—, —N(R^{d})C(O)N(R^{d})—, —OC(O)N(R^{d})—, or —C(O)N(R^{d})—, more preferably —O—, —S—, —N(R^{d})—, —C(O)O—, —C(O)S—, —N(R^{d})C(O)N(R^{d})—, —OC(O)N(R^{d})—, or —C(O)N(R^{d})—, and still more preferably —C(O)O— or —C(O)N(R^{d})—.

Q^{b1} is a single bond or an alkylene group. Note that the alkylene group may have —O—, a silphenylene skeleton group, or a dialkylsilylene group. The alkylene group may have a plurality of groups selected from the group consisting of —O—, a silphenylene skeleton group, a divalent organopolysiloxane residue, and a dialkylsilylene group.

Note that when the alkylene group has —O—, a silphenylene skeleton group, a divalent organopolysiloxane residue or a dialkylsilylene group, it preferably has these groups between carbon atoms.

The number of carbon atoms of the alkylene group represented by Q^{b1} is preferably 1 to 30, more preferably 1 to 20, still more preferably 2 to 20, and particularly preferably 2 to 6. Further, the aforementioned number of carbon atoms may be 1 to 10.

In particular, s1 is preferably 1, and Q^{b1} is preferably an alkylene group having a number of carbon atoms of 2 to 6.

Further, s1 is preferably 0, and Q^{b1} is preferably an alkylene group having a number of carbon atoms of 2 to 6.

Examples of [—(X³²)ₛ₁-Q^{b1}-Si(R)ₙL₃₋ₙ] in the group (3-1A-1) include groups shown below. In the below-shown formulas, * indicates a position of a bond with L³.

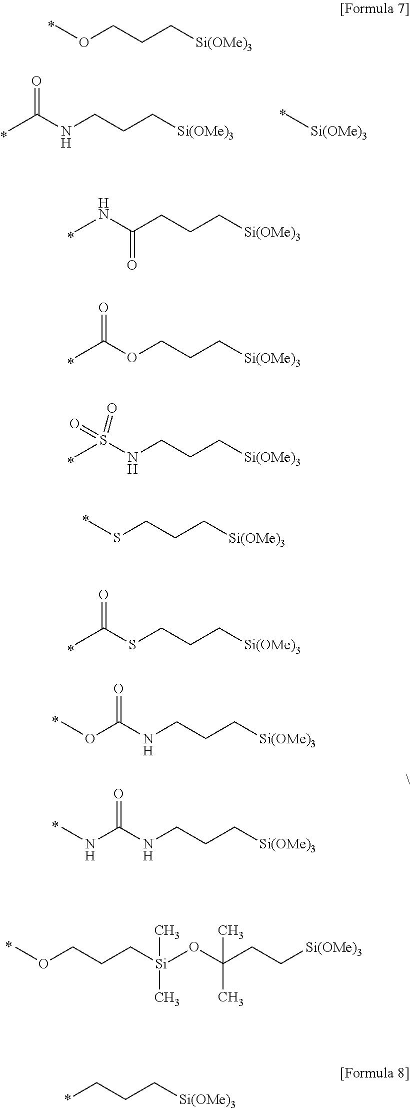

In the group (3-1A-2), X³³ is —O—, —S—, —N(R^{d})—, —C(O)—, —C(O)O—, —C(O)S—, —SO₂N(R^{d})—, —N(R^{d})C(O)—, —N(R^{d})C(O)N(R^{d})—, —OC(O)N(R^{d})—, or —C(O)N(R^{d})—.

The definition of R^{d} is the same as that described above.

s2 is 0 or 1. s2 is preferably 0 in view of the ease of the manufacturing of the compound.

In particular, X³³ is preferably —O—, —S—, —N(R^{d})—, —C(O)—, —C(O)O—, —C(O)S—, —SO₂N(R^{d})—, —N(R^{d})C(O)—, —N(R^{d})C(O)N(R^{d})—, —OC(O)N(R^{d})—, or —C(O)N(R^{d})—.

Q^{a2} is a single bond, an alkylene group, —C(O)—, or a group having, between carbon atoms of an alkylene group having a number of carbon atoms of 2 or greater, an etheric oxygen atom, —C(O)—, —C(O)O—, —C(O)N(R^{d})—, —N(R^{d})C(O)N(R^{d})—, —N(R^{d})C(O)O—, —SO₂N(R^{d})—, —C(O)N(R^{d})—, or —NH—.

The definition of R^{d} is the same as that described above.

The number of carbon atoms of the alkylene group represented by Q^{a2} is preferably 1 to 20, more preferably 1 to 10, still more preferably 1 to 6, and particularly preferably 1 to 3.

The number of carbon atoms of the group having, between carbon atoms of an alkylene group having a number of carbon atoms of 2 or greater, represented by Q^{a2}, an etheric oxygen atom, —C(O)—, —C(O)O—, —C(O)N(R^{d})—, —N(R^{d})C(O)N(R^{d})—, —N(R^{d})C(O)O—, —SO₂N(R^{d})—, —C(O)N(R^{d})—, or —NH— is preferably 2 to 10 and more preferably 2 to 6.

Q^{a2} is preferably a single bond in view of the ease of the manufacturing of the compound.

Q^{b2} is an alkylene group or a group having a divalent organopolysiloxane residue, an etheric oxygen atom, or —NH— between carbon atoms of an alkylene group having a number of carbon atoms of 2 or greater.

The number of carbon atoms of the alkylene group represented by Q^{b2} is preferably 1 to 30, more preferably 1 to 20, still more preferably 2 to 20, and may be 2 to 10 or 2 to 6. For example, the number of carbon atoms is 2, 3, 8, 9 or 11. Further, the number of carbon atoms may be 1 to 10.

The number of carbon atoms of the group having a divalent organopolysiloxane residue, an etheric oxygen atom, or —NH— between carbon atoms of an alkylene group having a number of carbon atoms of 2 or greater, represented by Q^{b2} is preferably 2 to 10 and more preferably 2 to 6.

Q^{b2} is preferably —CH₂CH₂CH₂— or —CH₂CH₂OCH₂CH₂CH₂— (note that the right end is bonded to Si) in view of the ease of the manufacturing of the compound.

The two [-Q^{b2}-Si(R)ₙL₃₋ₙ] may be the same as each other or different from each other.

Examples of [—(X³³)ₛ₂-Q^{a}2-N[-Q^{b2}-Si(R)ₙL₃₋ₙ]2] in the group (3-1A-2) include groups shown below. In the below-shown formulas, * indicates a position of a bond with L³.

Further, in the formula, a in (CH₂)_{α} that is bonded to a reactive silyl group is an integer indicating the number of methylene groups, is preferably 1 to 30, more preferably 1 to 20, still more preferably 2 to 20, and may be 2 to 10 or 2 to 6. For example, the number of carbon atoms is 2, 3, 8, 9 or 11. Further, the aforementioned number of carbon atoms may be 1 to 10. A plurality of a contained in the same compound may be the same as each other or different from each other, and is preferably the same as each other. For example, a plurality of a contained in the same compound are all 2, 3, 8, 9 or 11. The same applies hereinafter.

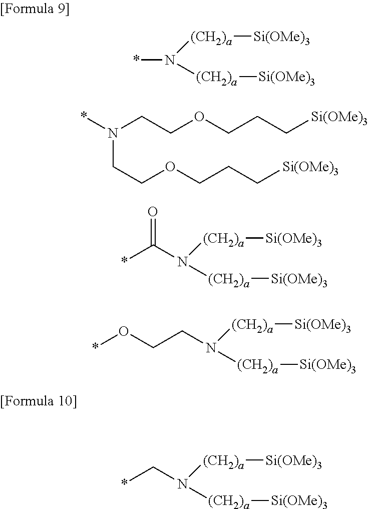

In the group (3-1A-3), Q^{a3} is a single bond, or an alkylene group which may have an etheric oxygen atom. In view of the ease of the manufacturing of the compound, Q^{a3} is preferably a single bond.

The number of carbon atoms of the alkylene group which may have an etheric oxygen atom is preferably 1 to 10 and more preferably 2 to 6.

R⁹ is a hydrogen atom, a hydroxyl group, or an alkyl group.

In view of the ease of the manufacturing of the compound, R⁹ is preferably a hydrogen atom or an alkyl group. The number of carbon atoms of the alkyl group is preferably 1 to 10, more preferably 1 to 4, and still more preferably 1(i.e. a methyl group).

Q^{b3} is an alkylene group, or a group having an etheric oxygen atom or a divalent organopolysiloxane residue between carbon atoms of an alkylene group having a number of carbon atoms of 2 or greater.

The number of carbon atoms of the alkylene group represented by Q^{b3} is preferably 1 to 30, more preferably 1 to 20, still more preferably 2 to 20, and may be 2 to 10 or 2 to 6. For example, the number of carbon atoms is 2, 3, 8, 9 or 11. Further, the aforementioned number of carbon atoms may be 1 to 10.

The number of carbon atoms of the group having an etheric oxygen atom or a divalent organopolysiloxane residue between carbon atoms of an alkylene group having a number of carbon atoms of 2 or greater, represented by Q^{b3} is preferably 2 to 20, more preferably 2 to 10, and still more preferably 2 to 6.

Q^{b3} is preferably —CH₂CH₂—, —CH₂CH₂CH₂—, or —CH₂CH₂CH₂CH₂CH₂CH₂CH₂CH₂— in view of the ease of the manufacturing of the compound.

The two [-Q^{b3}-Si(R)ₙL₃₋ₙ] may be the same as each other or different from each other.

Examples of the group (3-1A-3) include groups shown below. In the below-shown formulas, * indicates a position of a bond with L².

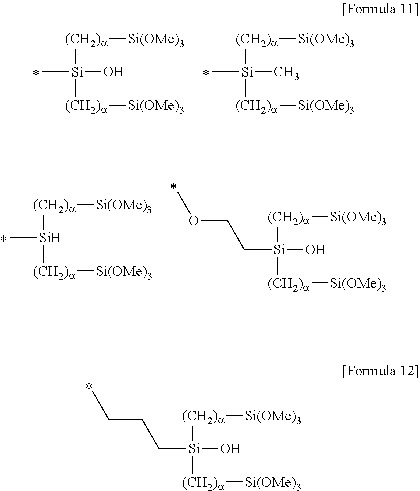

In the group (3-1A-4), Q^{e} is —C(O)O—, —SO₂N(R^{d})—, or —N(R^{d})C(O)—.

The definition of R³¹ is the same as that described above. When w1 is 1 or 2, R³¹ is preferably a hydrogen atom.

s4 is 0 or 1.

Q^{a4} is a single bond, or an alkylene group which may have an etheric oxygen atom.

The number of carbon atoms of the alkylene group which may have an etheric oxygen atom is preferably 1 to 20, more preferably 1 to 10, still more preferably 1 to 6, and particularly preferably 1 to 3.

t4 is 0 or 1 (note that it is 0 when Q^{a4} is a single bond).

In view of the ease of the manufacturing of the compound, when s4 is 0, -Q^{a4}-(O)ₜ₄- is preferably a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂— (note that the left side is bonded to (XO)ₘ). Further, when s4 is 1, it is preferably a single bond, —CH₂—, or —CH₂CH₂—.

Q^{b4} is an alkylene group, and the aforementioned alkylene group may have —O—, —C(O)N(R^{d})— (the definition of R^{d} is the same as that described above), a silphenylene skeleton group, a divalent organopolysiloxane residue, or a dialkylsilylene group.

Note that when the alkylene group has —O— or a silphenylene skeleton group, it preferably has —O— or a silphenylene skeleton group between carbon atoms. Further, when the alkylene group has a —C(O)N(R^{d})—, a dialkylsilylene group, or a divalent organopolysiloxane residue, it preferably has these groups between carbon atoms or at the end on the side on which the alkylene group is bonded to (O)ᵤ₄.

The number of carbon atoms of the alkylene group represented by Q^{b4} is preferably 1 to 30, more preferably 1 to 20, still more preferably 2 to 20, and may be 2 to 11 or 2 to 6. For example, the number of carbon atoms is 2, 3, 8, 9 or 11. Further, the aforementioned number of carbon atoms may be 1 to 11.

u4 is 0 or 1.

In view of the ease of the manufacturing of the compound, —(O)ᵤ₄ -Q^{b4}- is preferably —CH₂CH₂—, —CH₂CH₂CH₂—, —(CH₂)_{b}—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, or —CH₂CH₂CH₂Si(CH₃)₂PhSi(CH₃)₂CH₂CH₂— (note that the right end is bonded to Si). b is an integer of 4 to 11.

w1 is an integer of 0 to 2, preferably 0 or 1, and more preferably 0.

When there are two or more [—(O)ᵤ₄-Q^{b4}-Si(R)ₙL₃₋ₙ], the two or more [—(O)ᵤ₄-Q^{b4}-Si(R)ₙL₃n] may be the same as each other or different from each other. When there are two or more R³¹, the two or more (—R³¹) may be the same as each other or different from each other.

Examples of [-[Q^{e}]s4-Q^{a4}-(O)ₜ₄-C[—(O)ᵤ₄-Q^{b4}-Si(R)ₙL₃₋ₙ]_{3-w1}(—R³¹)_{w1}] in the group (3-1A-4) include groups shown below. In the below-shown formulas, * indicates a position of a bond with L³.

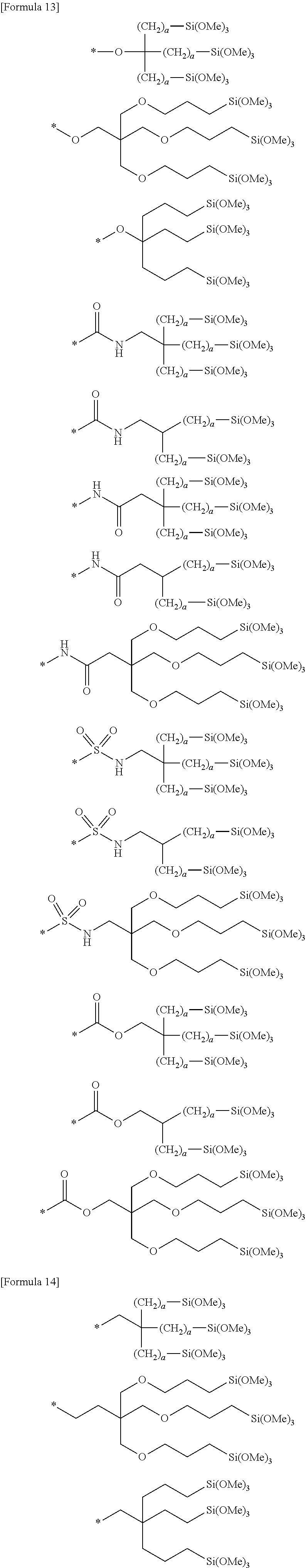

In the group (3-1A-5), Q^{a5} is an alkylene group which may have an etheric oxygen atom.

The number of carbon atoms of the alkylene group which may have an etheric oxygen atom is preferably 1 to 10 and particularly preferably 2 to 6.

Q^{a5} is preferably —OCH₂CH₂CH₂—, —OCH₂CH₂OCH₂CH₂CH₂—, —CH₂CH₂—, or —CH₂CH₂CH₂— (note that the right end is bonded to Si) in view of the ease of the manufacturing of the compound.

Q^{b5} is an alkylene group, or a group which has an etheric oxygen atom or a divalent organopolysiloxane residue between carbon atoms of an alkylene group having a number of carbon atoms of 2 or greater.

The number of carbon atoms of the alkylene group represented by Q^{b5} is preferably 1 to 30, more preferably 1 to 20, still more preferably 2 to 20, and may be 2 to 10 or 2 to 6. For example, the number of carbon atoms is 2, 3, 8, 9 or 11. Further, the aforementioned number of carbon atoms may be 1 to 10.

The number of carbon atoms of the group having an etheric oxygen atom or a divalent organopolysiloxane residue between carbon atoms of an alkylene group having a number of carbon atoms of 2 or greater, represented by Q^{b5} is preferably 2 to 20, more preferably 2 to 10, and still more preferably 2 to 6.

Q^{b5} is preferably —CH₂CH₂CH₂— or —CH₂CH₂OCH₂CH₂CH₂— in view of the ease of the manufacturing of the compound (note that the right end is bonded to Si(R)ₙL₃₋ₙ).

The three [-Q^{b5}-Si(R)ₙL₃₋ₙ] may be the same as each other or different from each other.

Examples of [-Q^{a5}-Si[-Q^{b5}-Si(R)ₙL₃₋ₙ]₃] in the group (3-1A-5) include groups shown below. In the below-shown formulas, * indicates a position of a bond with L³.

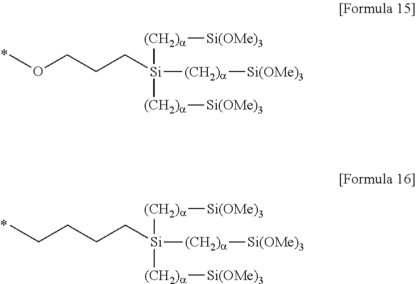

The definition of Q^{e} in the group (3-1A-6) is the same as that defined in the above-described group (3-1A-4).

v is 0 or 1.

Q^{a6} is an alkylene group which may have an etheric oxygen atom.

The number of carbon atoms of the alkylene group which may have an etheric oxygen atom is preferably 1 to 10 and particularly preferably 2 to 6.

Q^{a6} is preferably —CH₂OCH₂CH₂CH₂—, —CH₂OCH₂CH₂OCH₂CH₂CH₂—, —CH₂CH₂—, or —CH₂CH₂CH₂— in view of the ease of the manufacturing of the compound (note that the right end is bonded to Z^{a}).

Z^{a} is an organopolysiloxane residue having a valence of (w2+1), or a group having a valence of (w2+1) and having an alkylene group between organopolysiloxane residues.

w2 is an integer of 2 to 7.

Examples of the organopolysiloxane residue having a valence of (w2+1), and the group having a valence of (w2+1) and having an alkylene group between organopolysiloxane residues include groups shown below. Note that R^{a} in the below-shown formulas is the same as that described above. * indicates a bonding position.

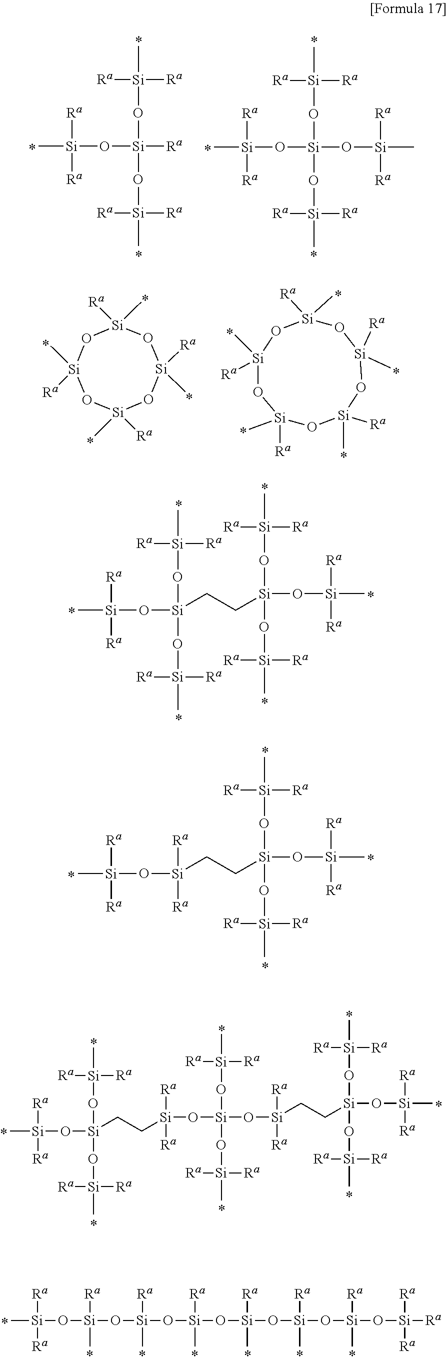

Q^{b6} is an alkylene group, or a group having an etheric oxygen atom or a divalent organopolysiloxane residue between carbon atoms of an alkylene group having a number of carbon atoms of 2 or greater.

The number of carbon atoms of the alkylene group represented by Q^{b6} is preferably 1 to 30, more preferably 1 to 20, still more preferably 2 to 20, and may be 2 to 10 or 2 to 6. For example, the number of carbon atoms is 2, 3, 8, 9 or 11. Further, the aforementioned number of carbon atoms may be 1 to 10.

The number of carbon atoms of the group having an etheric oxygen atom or a divalent organopolysiloxane residue between carbon atoms of an alkylene group having a number of carbon atoms of 2 or greater, represented by Q^{b6} is preferably 2 to 20, more preferably 2 to 10, and still more preferably 2 to 6.

Q^{b6} is preferably —CH₂CH₂— or —CH₂CH₂CH₂— in view of the ease of the manufacturing of the compound.

w2 [-Q^{b6}-Si(R)ₙL₃₋ₙ](i.e., w2 units each represented by [-Q^{b6}-Si(R)ₙL₃₋ₙ]) may be the same as each other or different from each other.

Examples of [-[Q^{e}]ᵥ-Q^{a6}-Z^{a}[-Q^{b6}-Si(R)ₙL₃₋ₙ]w₂] in the group (3-1A-6) include groups shown below. In the below-shown formulas, * indicates a position of a bond with L³.

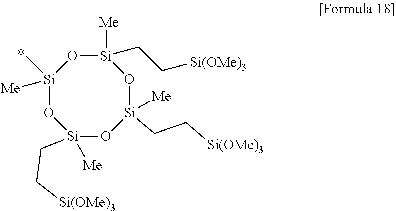

In the group (3-1A-7), Z^{c} is a hydrocarbon group having a valence of (w3+w4+1).

w3 is an integer of 4 or greater.

w4 is an integer of 0 or greater.

The definitions and the preferred ranges of Q^{e}, s4, Q^{a4}, t4, Q^{b4}, and u4 are the same as those of the same symbols in the group (3-1A-4).

Z^{c} may consist of a hydrocarbon chain, may have an etheric oxygen atom between carbon atoms of a hydrocarbon chain, and preferably consists of a hydrocarbon chain.

The valence of Z^{c} is preferably 5 to 20, more preferably 5 to 10, still more preferably 5 to 8, and particularly preferably 5 to 6.

The number of carbon atoms of Z^{c} is preferably 3 to 50, more preferably 4 to 40, and still more preferably 5 to 30.

w3 is preferably 4 to 20, more preferably 4 to 16, still more preferably 4 to 8, and particularly preferably 4 to 5.

w4 is preferably 0 to 10, more preferably 0 to 8, still more preferably 0 to 6, particularly preferably 0 to 3, and most preferably 0 to 1.

When there are two or more [—(O-Q^{b4})ᵤ₄-Si(R)ₙL₃₋ₙ], the two or more [—(O-Q^{b4})ᵤ₄-Si(R)ₙL₃₋ₙ] may be the same as each other or different from each other.

Examples of the group (3-1A-7) include groups shown below. In the below-shown formulas, * indicates a position of a bond with L³.

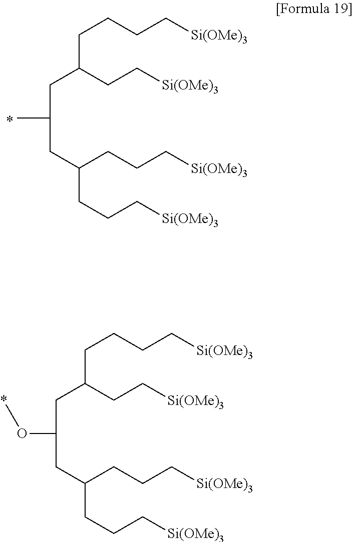

A in Formula (1-1) may be a group (g2-1) (note that d1+d3=1 and q=d2+d4), a group (g2-2) (note that q=e2), a group (g2-3) (note that q=2), a group (g2-4) (note that q=h2), a group (g2-5) (note that q=i2), a group (g2-6) (note that q=1), or a group (g2-7) (note that q=1+i3).

Among them, A is preferably a group (g2-2) or a group (g2-6).

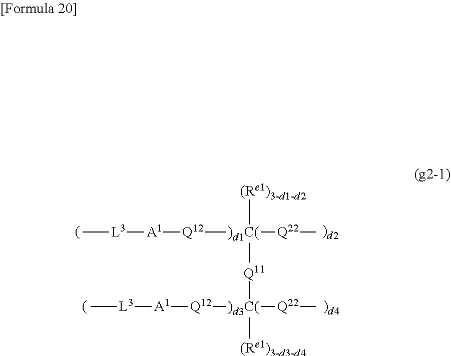

-L³-A¹-Q¹²-C(R^{e2})₃₋ₑ₂(-Q²²-)ₑ₂ (g2-2)

-L³-A¹-Q¹³-N(-Q²³-)₂ (g2-3)

-L³-A¹-Q¹⁴-Z¹(-Q²⁴-)ₕ₂ (g2-4)

-L³-A¹-Q¹⁵-Si(R^{e3})₃₋ᵢ₂(-Q²⁵-)ᵢ₂ (g2-5) -L³-A¹-Q²⁶- (g2-6)

-L³-A¹-Q¹²-CH(-Q²²-)—Si(R^{e3})₃₋ᵢ₃(-Q²⁵-)ᵢ₃ (g2-7)

Note that in Formulas (g2-1) to (g2-7), the L³ side is bonded to L², and the Q²², Q²³, Q²⁴, Q²⁵ or Q²⁶ side is bonded to [—Si(R)ₙL₃₋ₙ].

The definition of L³ is the same as that described above.

A¹ is a single bond, —C(O)NR⁶—, —C(O)—, —OC(O)O—, —NHC(O)O—, —NHC(O)NR⁶—, —O—, or —SO₂NR⁶—.

Q¹¹ is a single bond, —O—, an alkylene group, or a group having —C(O)NR⁶—, —C(O)—, —NR⁶—, or —O— between carbon atoms of an alkylene group having a number of carbon atoms of 2 or greater.

Q¹² is a single bond, an alkylene group, or a group having —C(O)NR⁶—, —C(O)—, —NR⁶—, or —O— between carbon atoms of an alkylene group having a number of carbon atoms of 2 or greater. Further, when A has two or more Q¹², the two or more Q¹² may be the same as each other or different from each other.

Q¹³ is a single bond (note that A¹ is —C(O)—), an alkylene group, a group having —C(O)NR⁶—, —C(O)—, —NR⁶—, or —O— between carbon atoms of an alkylene group having a number of carbon atoms of 2 or greater, or a group having —C(O)— at the end on the N side of an alkylene group.

Q¹⁴ is Q¹² when the atom in Z¹ to which Q¹⁴ is bonded is a carbon atom, and is Q¹³ when the atom in Z¹ to which Q¹⁴ is bonded is a nitrogen atom. Further, when A² has two or more Q¹⁴, the two or more Q¹⁴ may be the same as each other or different from each other.

Q¹⁵ is an alkylene group, or a group having —C(O)NR⁶—, —C(O)—, —NR⁶—, or —O— between carbon atoms of an alkylene group having a number of carbon atoms of 2 or greater. Further, when A has two or more Q¹⁵, the two or more Q¹⁵ may be the same as each other or different from each other.

Q²² is an alkylene group, a group having —C(O)NR⁶—, —C(O)—, —NR⁶—, or —O— between carbon atoms of an alkylene group having a number of carbon atoms of 2 or greater, a group having —C(O)NR⁶—, —C(O)—, —NR⁶—, or —O— at the end on the side on which the alkylene group is not connected to Si, or a group having —C(O)NR⁶—, —C(O)—, —NR⁶—, or —O— between carbon atoms of an alkylene group having a number of carbon atoms of 2 or greater and having —C(O)NR⁶—, —C(O)—, —NR⁶—, or —O— at the end on the side on which the alkylene group is not connected to Si. Further, when A has two or more Q²², the two or more Q²² may be the same as each other or different from each other.

Q²³ is an alkylene group, or a group having —C(O)NR⁶—, —C(O)—, —NR⁶—, or —O— between carbon atoms of an alkylene group having a number of carbon atoms of 2 or greater. Further, the two Q²³ may be the same as each other or different from each other.

Q²⁴ is Q²² when the atom in Z¹ to which Q²⁴ is bonded is a carbon atom, and is Q²³ when the atom in Z¹ to which Q²⁴ is bonded is a nitrogen atom. Further, when A has two or more Q²⁴, the two or more Q²⁴ may be the same as each other or different from each other.

Q²⁵ is an alkylene group or a group having —C(O)NR⁶—, —C(O)—, —NR⁶—, or —O— between carbon atoms of an alkylene group having a number of carbon atoms of 2 or greater. Further, when A has two or more Q²⁵, the two or more Q²⁵ may be the same as each other or different from each other.

Q²⁶ is an alkylene group, or a group having —C(O)NR⁶—, —C(O)—, —NR⁶—, or —O— between carbon atoms of an alkylene group having a number of carbon atoms of 2 or greater.

When Q²², Q²³, Q²⁴, Q²⁵ and Q²⁶ are alkylene groups, the number of carbon atoms is preferably 1 to 60 and more preferably 1 to 30. The number of carbon atoms may be 1 to 20, 1 to 10, or 1 to 6.

Z¹ is a group having a ring structure having a valence of (1+h2), having a carbon atom or a nitrogen atom to which Q¹⁴ is directly bonded, and having a carbon atom or a nitrogen atom to which Q²⁴ is directly bonded.

R^{e1} is a hydrogen atom or an alkyl group, and two or more R^{e1} may be the same as each other or different from each other.

R^{e2} is a hydrogen atom, a hydroxyl group, an alkyl group, or an acyloxy group.

R^{e3} is an alkyl group. R⁶ is a hydrogen atom, an alkyl group having a number of carbon atoms of 1 to 6, or a phenyl group having a number of carbon atoms of 1 to 6.

d1 is 0 or 1. d3 is 0 or 1. Further, d1+d3 is 1.

d2 is an integer of 0 to 3. d4 is an integer of 0 to 3. Further, d2+d4 is an integer of 1 to 5.

d1+d2 is an integer of 1 to 3.

d3+d4 is an integer of 1 to 3.

e2 is 2 or 3.

h2 is an integer of 1 or greater, and preferably 2 or 3.

i2 is an integer of 1 to 3, and preferably 2 or 3.

i3 is 2 or 3.

The number of carbon atomss of the alkylene groups of Q¹¹, Q¹², Q¹³, Q¹⁴, Q¹⁵, Q²², Q²³, Q²⁴, Q²⁵ and Q²⁶ are preferably 1 to 30, more preferably 1 to 20, still more preferably 2 to 20, and may be 2 to 10 or 2 to 6 in view of the ease of the manufacturing of the compound and because the abrasion resistance of the surface-treated layer becomes more excellent. For example, the number of carbon atoms is 2, 3, 8, 9 or 11. Further, the aforementioned number of carbon atoms may be 1 to 10, 1 to 6, or 1 to 4. However, when the alkylene group has a specific bond between carbon atoms, the lower limit value of its number of carbon atoms is 2.

Examples of the ring structure in Z¹ include the ring structures described above, and its preferred forms are also similar to those described above. Note that Q¹⁴ and Q²⁴ are directly bonded to the ring structure in Z¹, so that a situation in which, for example, the alkylene group is bonded to the ring structure, and Q¹⁴ and Q²⁴ are bonded to the alkylene group never occurs.

The number of carbon atoms of the alkyl group of R^{e1}, R^{e2} or R^{e3} is preferably 1 to 6, more preferably 1 to 3, and still more preferably 1 to 2 in view of the ease of the manufacturing of the compound.

The number of carbon atoms of the alkyl group moiety of the acyloxy group of R^{e2} is preferably 1 to 6, more preferably 1 to 3, and still more preferably 1 to 2 in view of the ease of the manufacturing of the compound.

h2 is preferably 2 to 6, more preferably 2 to 4, and still more preferably 2 or 3 in view of the ease of the manufacturing of the compound and because the abrasion resistance of the surface-treated layer becomes more excellent.

Examples of other forms of A include a group (g2-8) (note that d1+d3=1, q=d2×k3+d4×k3), a group (g2-9) (note that q=e2×k3), a group (g2-10) (note that q=2×k3), a group (g2-11) (note that q=h2×k3), a group (g2-12) (note that q=i2×k3), a group (g2-13) (note that q=k3), or a group (g2-14) (note that q=i3×k3+k3).

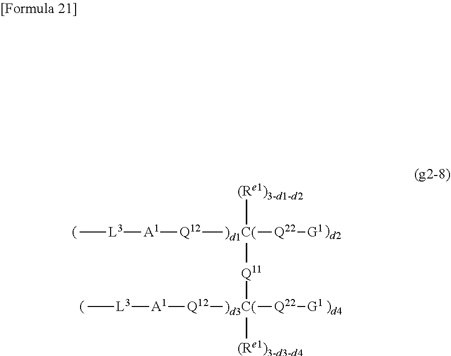

-L³-A¹-Q¹²-C(R^{e2})₃₋ₑ₂(-Q²²-G¹)ₑ₂ (g2-9)

-L³-A¹-Q¹³-N(-Q²³-G¹)₂ (g2-10)

-L³-A¹-Q¹⁴-Z¹(-Q²⁴-G¹)ₕ₂ (g2-11)

-L³-A¹-Q¹⁵-Si(R^{e3})₃₋ᵢ₂(-Q²⁵-G¹)ᵢ₂ (g2-12)

-L³-A¹-Q²⁶-G¹ (g2-13)

-L³-A¹-Q¹²-CH(-Q²²-G¹)—Si(R^{e3})₃₋ᵢ₃(-Q²⁵-G¹)ᵢ₃ (g2-14)

Note that in Formulas (g2-8) to (g2-14), the L³ side is bonded to L², and the G¹ side is bonded to [—Si(R)ₙL₃₋ₙ].

G¹ is the below-shown group (g3), and two or more G¹ included in A may be the same as each other or different from each other. Symbols other than G¹ are similar to those in Formulas (g2-1) to (g2-7).

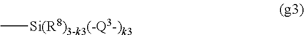

However, in the group (g3), the Si side is connected to Q²², Q²³, Q²⁴, Q²⁵ and Q²⁶, and the Q³ side is connected to [—Si(R)ₙL₃₋ₙ]. R⁸ is an alkyl group. Q³ is an alkylene group, a group having —C(O)NR⁶—, —C(O)—, —NR⁶—, or —O— between carbon atoms of an alkylene group having a number of carbon atoms of 2 or greater, or (OSi(R⁹)₂)ₚ—O—. Further, two or more Q³ may be the same as each other or different from each other. k3 is 2 or 3. R⁶ is a hydrogen atom, an alkyl group having a number of carbon atoms of 1 to 6, or a phenyl group having a number of carbon atoms of 1 to 6. R⁹ is an alkyl group, a phenyl group, or an alkoxy group, and two R⁹ may be the same as each other or different from each other. p is an integer of 0 to 5. Further, when p is 2 or greater, two or more (OSi(R⁹)₂) may be the same as each other or different from each other.

The number of carbon atoms of the alkylene group of Q³ is preferably 1 to 30, more preferably 1 to 20, still more preferably 2 to 20, and may be 2 to 10 or 2 to 6 in view of the ease of the manufacturing of the compound and because the abrasion resistance of the surface-treated layer becomes more excellent. For example, the number of carbon atoms is 2, 3, 8, 9 or 11. Further, the aforementioned number of carbon atoms may be 1 to 10, 1 to 6, or 1 to 4. However, when the alkylene group has a specific bond between carbon atoms, the lower limit value of its number of carbon atoms is 2.

The number of carbon atoms of the alkyl group of R⁸ is preferably 1 to 6, more preferably 1 to 3, and still more preferably 1 to 2 in view of the ease of the manufacturing of the compound.

The number of carbon atoms of the alkyl group of R⁹ is preferably 1 to 6, more preferably 1 to 3, and still more preferably 1 to 2 in view of the ease of the manufacturing of the compound.

The number of carbon atoms of the alkoxy group of R⁹ is preferably 1 to 6, more preferably 1 to 3, and still more preferably 1 to 2 because the storage stability of the compound becomes more excellent.

p is preferably 0 or 1.

Examples of compounds according to the present disclosure include compounds represented by the below-shown formulas. The compounds represented by the below-shown formulas are preferred because they are industrially manufactured with ease, are easy to handle, and because the water repellency and the abrasion resistance of the surface-treated layer are more excellent. R^{t} in the compounds represented by the below-shown formula is similar to that in the above-described [T-O—(Si(R²)₂—O)ₘₐ—Si(R²)₂-L¹⁻L²⁻L³⁻], and its preferred forms are also similar to those described above.

Examples of the compound in which A in Formula (1-1) is the group (g2-1) include compounds represented by the below-shown formulas.

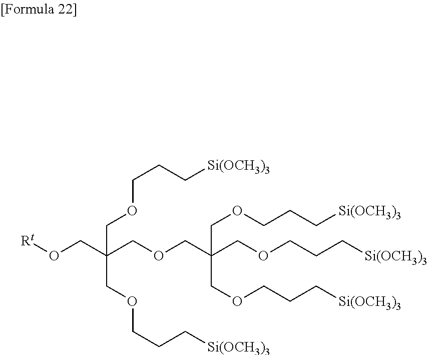

Examples of the compound in which A in Formula (1-1) is the group (g2-2) include compounds represented by the below-shown formulas. In the below-shown formulas, Ak represents an alkyl group (e.g., an alkyl group having a number of carbon atoms of 1 to 15).

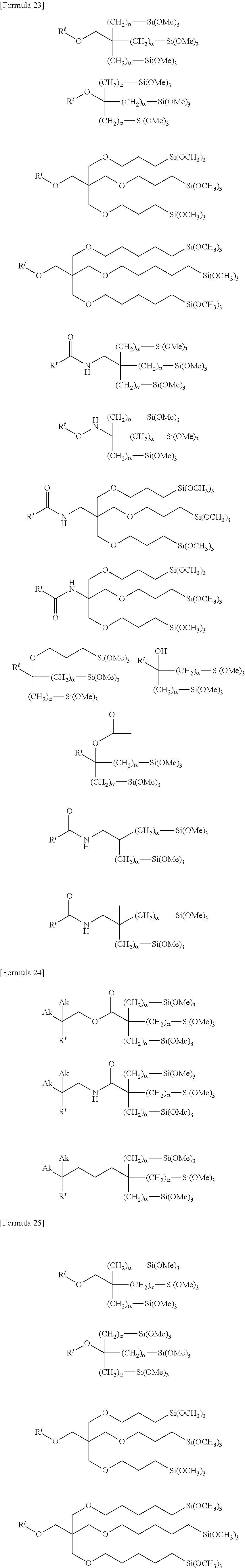

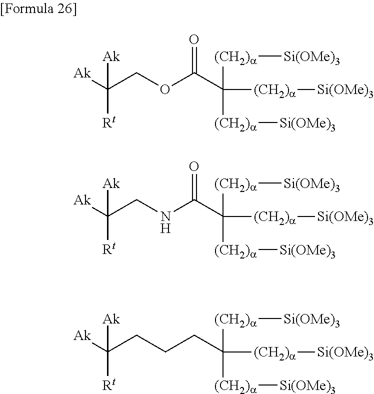

Examples of the compound in which A in Formula (1-1) is the group (g2-3) include compounds represented by the below-shown formulas.

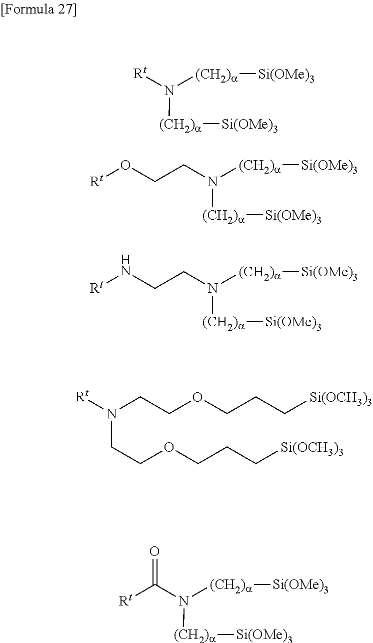

Examples of the compound in which A in Formula (1-1) is the group (g2-4) include compounds represented by the below-shown formulas.

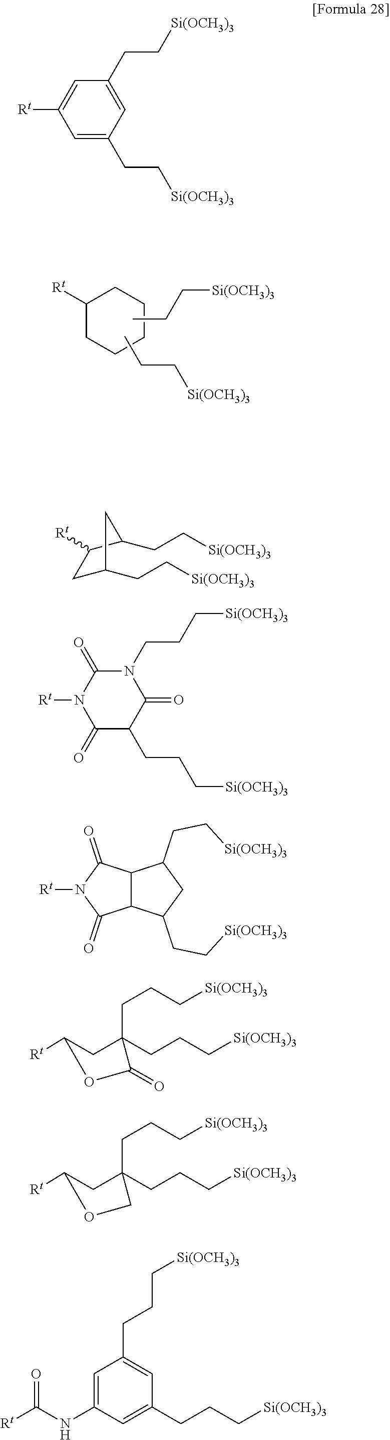

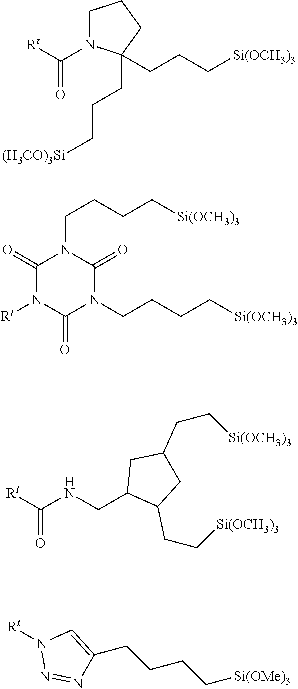

Examples of the compound in which A in Formula (1-1) is the group (g2-5) include compounds represented by the below-shown formulas.

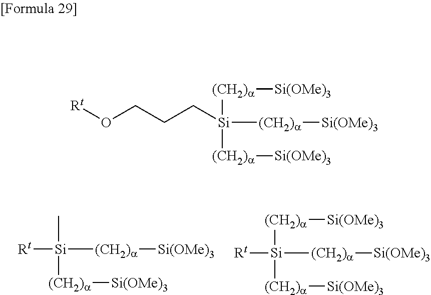

Examples of the compound in which A in Formula (1-1) is the group (g2-6) include compounds represented by the below-shown formulas.

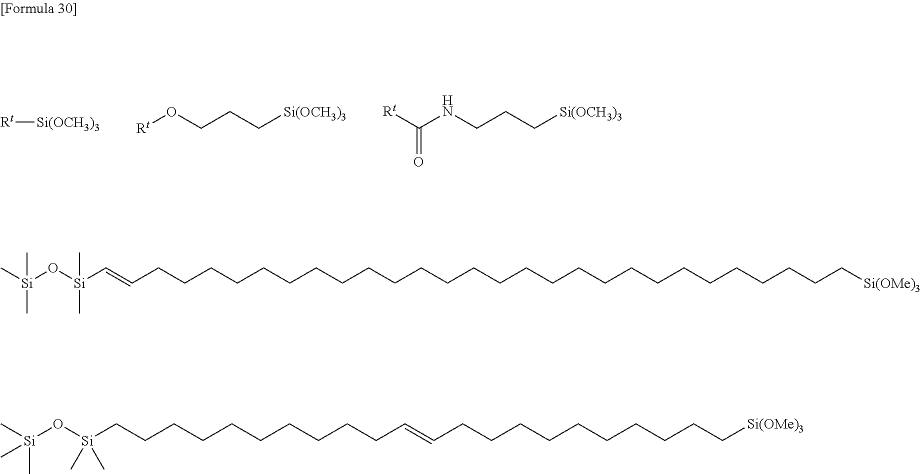

Examples of the compound in which A in Formula (1-1) is the group (g2-7) include compounds represented by the below-shown formulas.

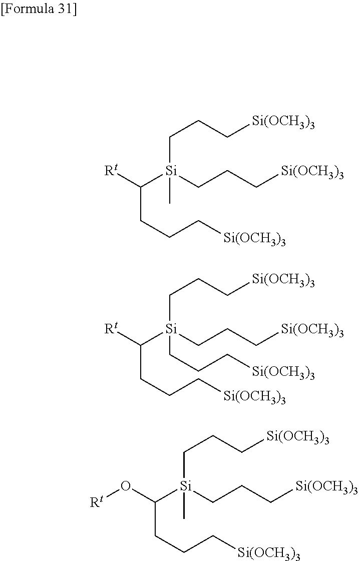

Examples of the compound in which A in Formula (1-1) is the group (g2-8) include compounds represented by the below-shown formulas.

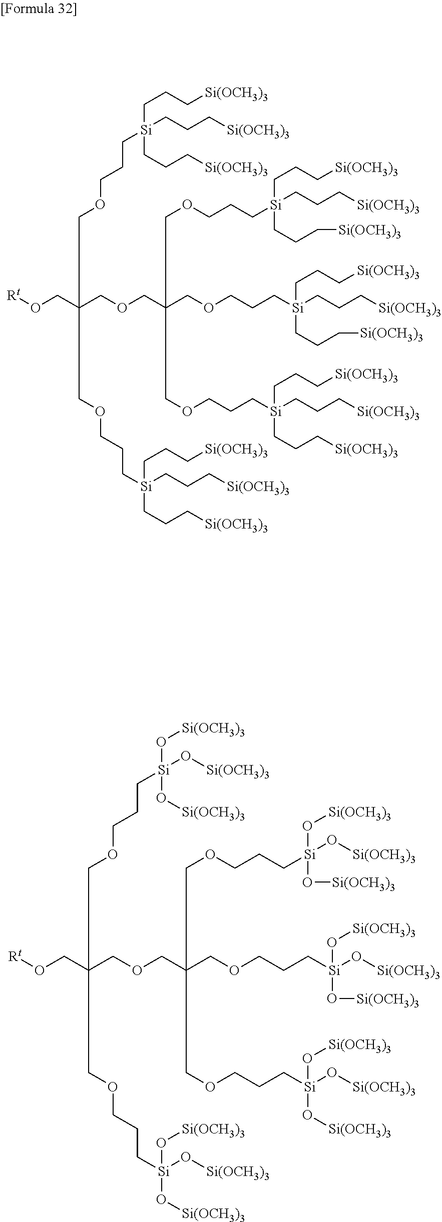

Examples of the compound in which A in Formula (1-1) is the group (g2-9) include compounds represented by the below-shown formulas.

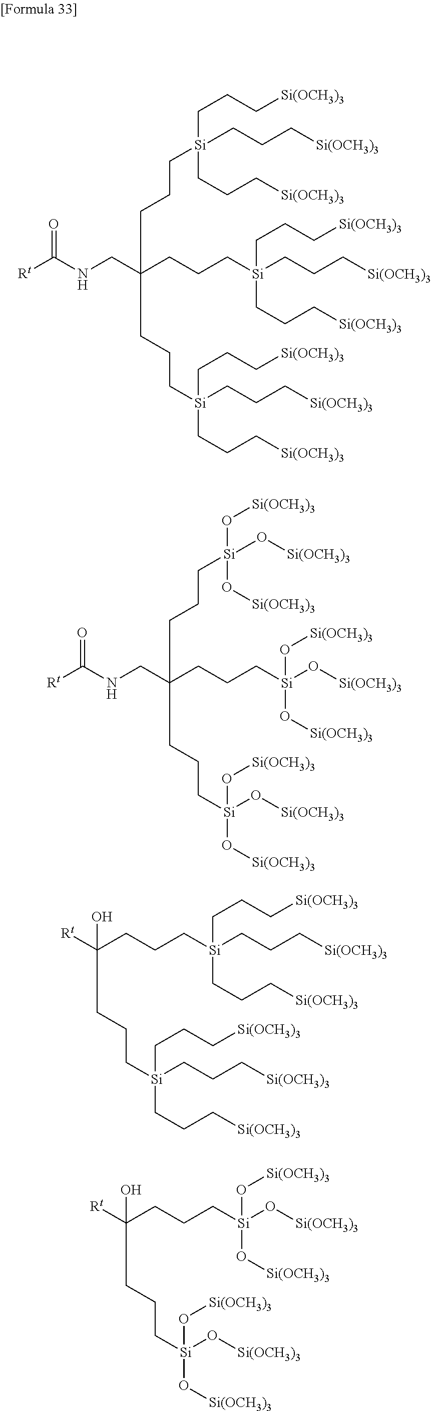

Examples of the compound in which A in Formula (1-1) is the group (g2-10) include compounds represented by the below-shown formulas.

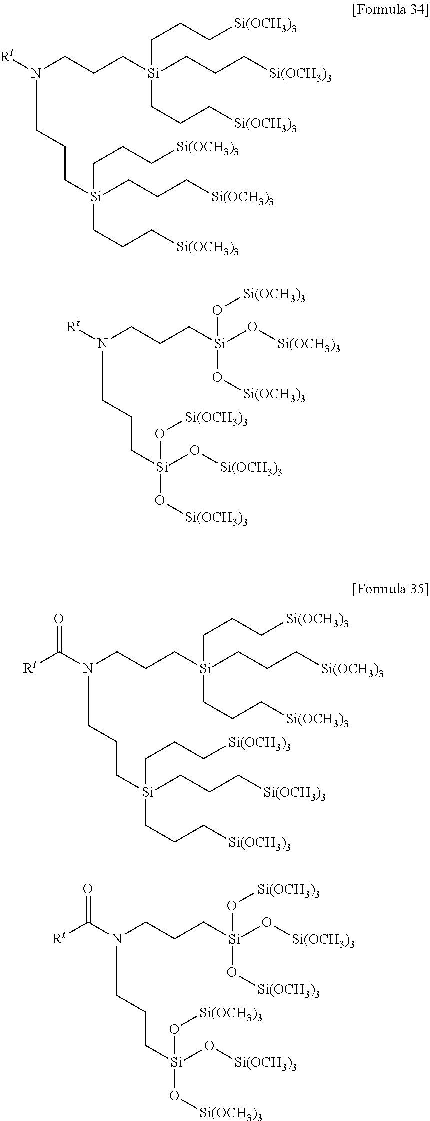

Examples of the compound in which A in Formula (1-1) is the group (g2-11) include compounds represented by the below-shown formulas.

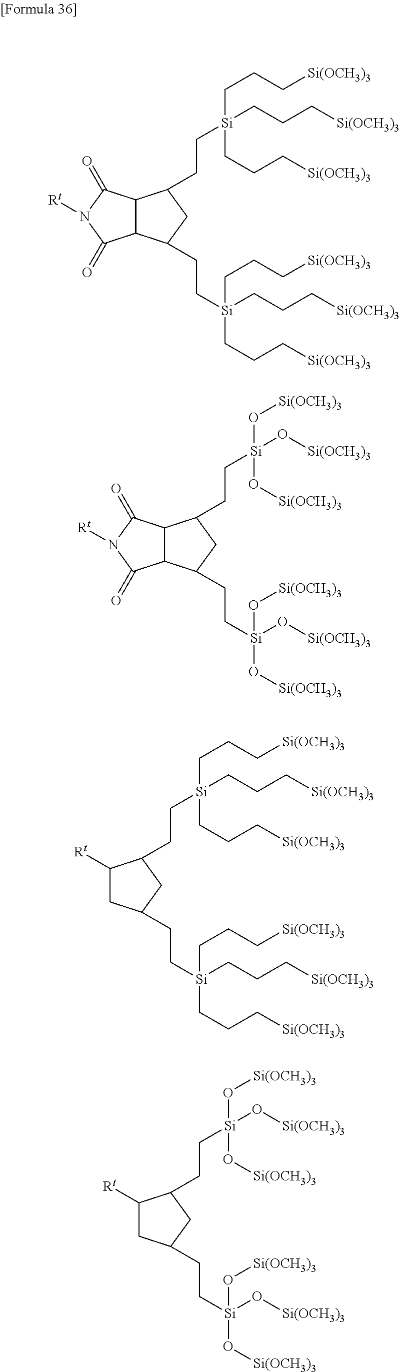

Examples of the compound in which A in Formula (1-1) is the group (g2-12) include compounds represented by the below-shown formulas.

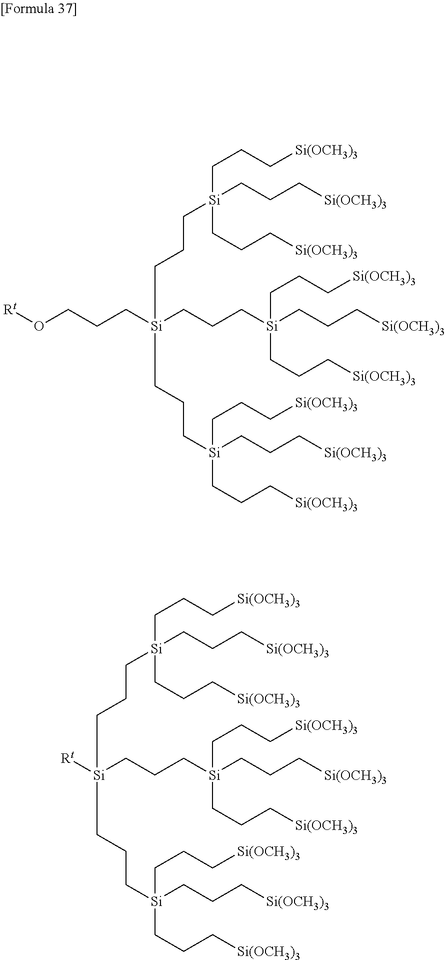

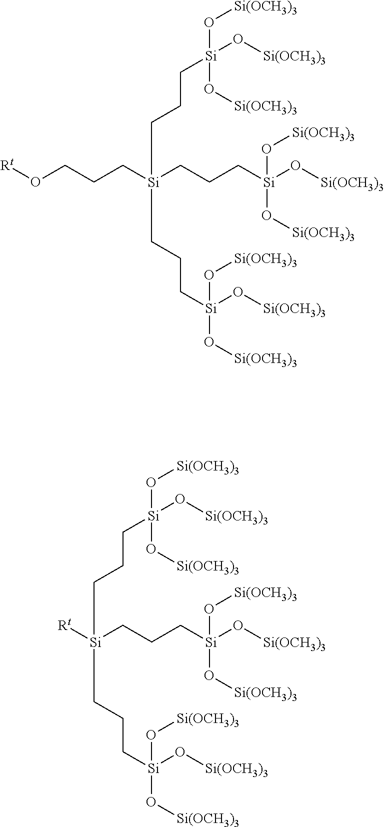

Examples of the compound in which A in Formula (1-1) is the group (g2-13) include compounds represented by the below-shown formulas.

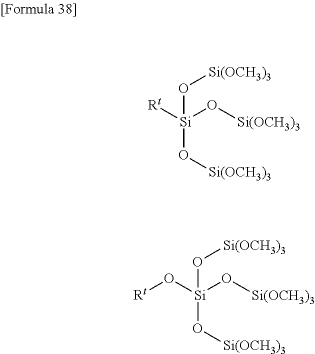

Examples of the compound in which A in Formula (1-1) is the group (g2-14) include compounds represented by the below-shown formulas.

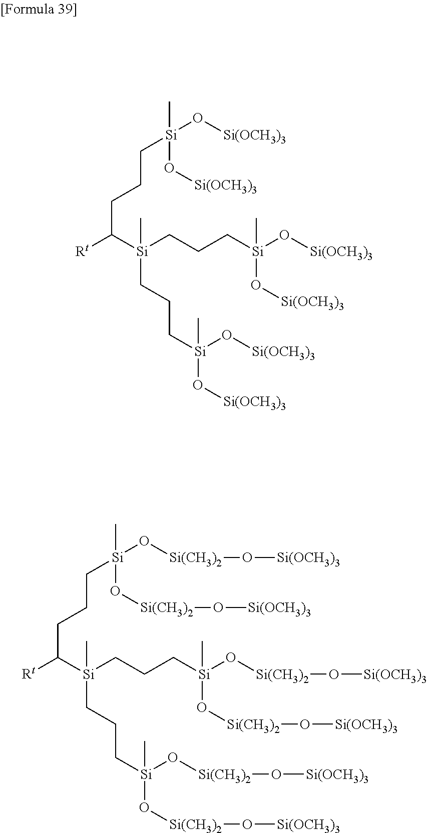

Examples of the compound represented by Formula (1-1) include compounds shown below. The definition of ma is the same as that described above.

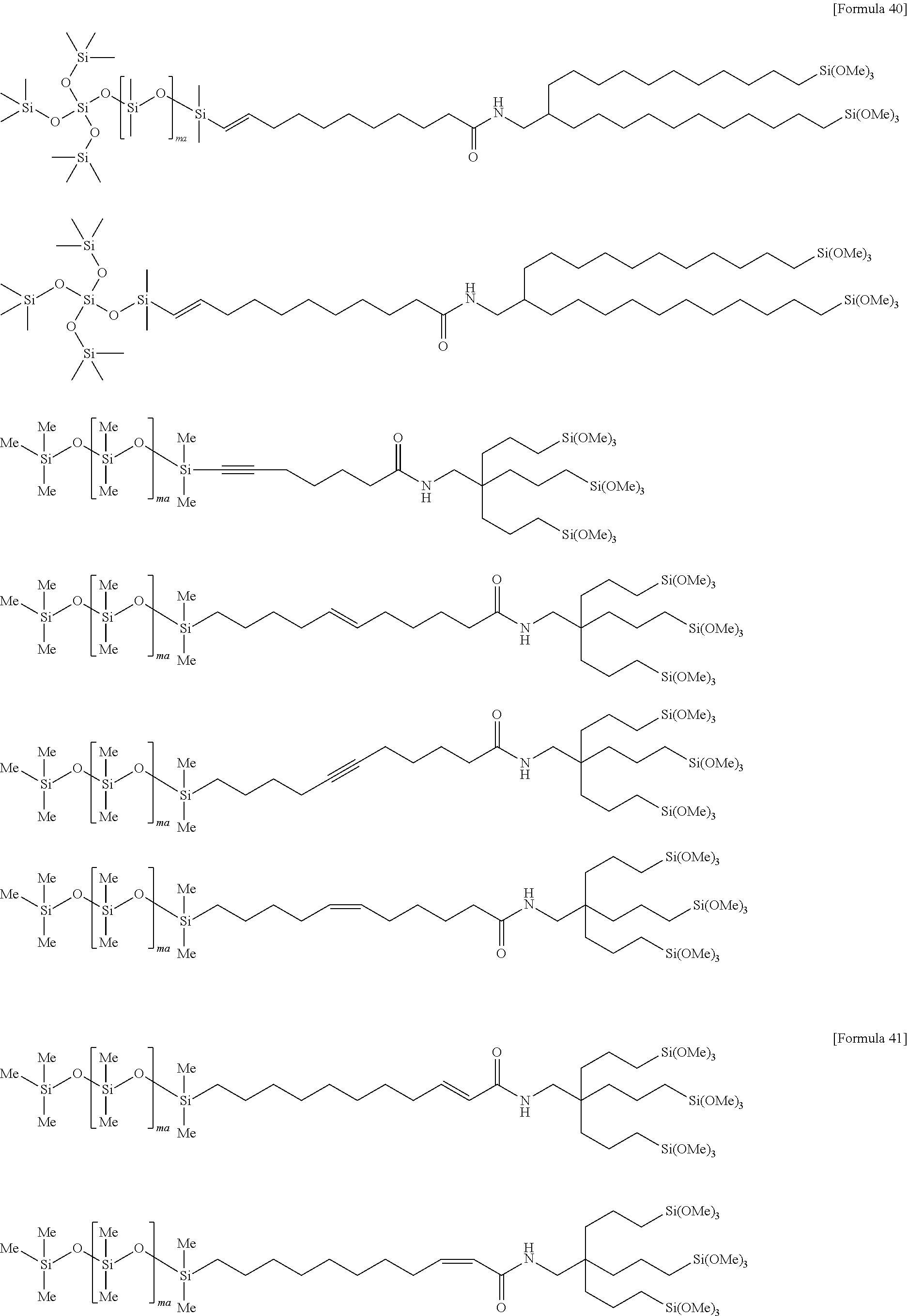

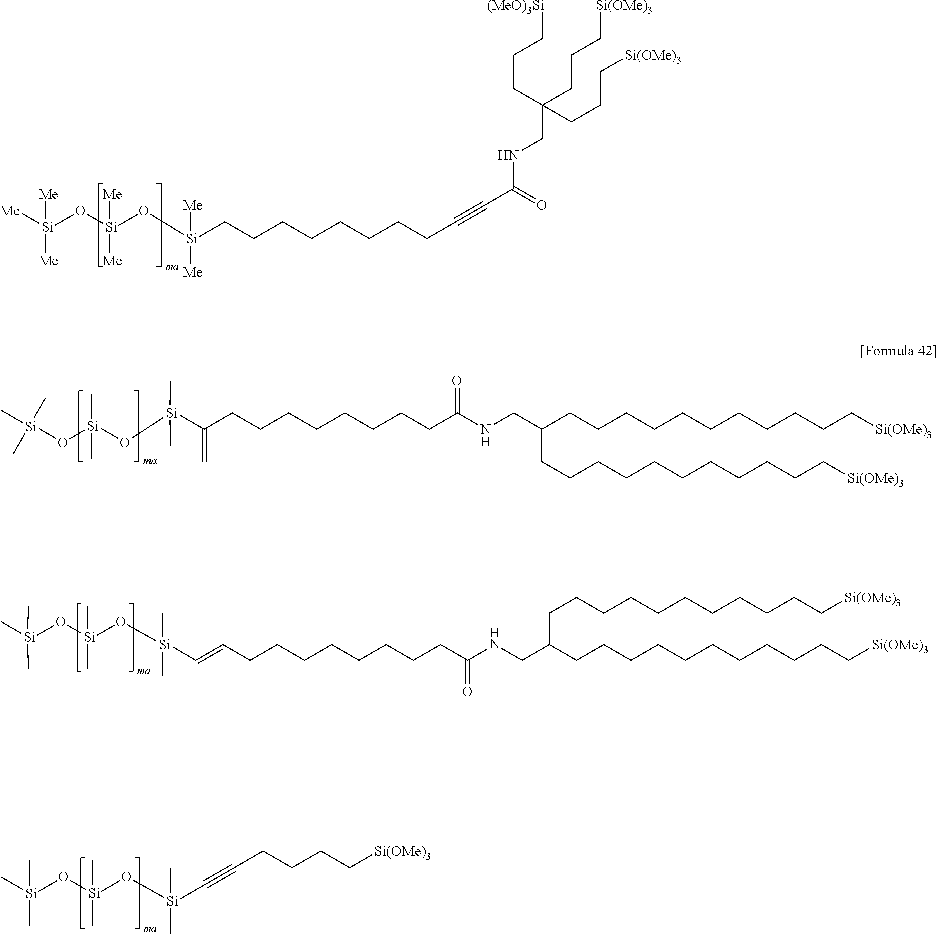

Further, the compound (1-1) may be a compound in which: L¹ is an alkylene group; L² is —CH═CH—, —C≡C—, or —C(═CH₂)—; and L³ is an alkylene group. The alkylene groups of L¹ and L³ may be linear or branched, and are preferably linear. The number of carbon atoms of each of L¹ and L³ is preferably 1 to 30, and may be 1 to 25, 1 to 20, 1 to 10, or 5 to 10. For example, each of L¹ and L³ may be an alkylene group having a number of carbon atoms of 1 to 10 or 5 to 10, and L² may be a combination of —CH═CH—, —C≡C—, or —C(═CH₂)—. Note that in the compounds in the above-described preferred ranges and preferred combinations, q may be 1.

### Compound Represented by Formula (1-2)

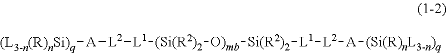

In Formula (1-2),
R² is each independently a hydrocarbon group,
L¹ is a single bond or a divalent linking group,
L² is —CH═CH—, —C≡C—, or —C(═CH₂)—,
A is a single bond or a linking group having a valence of (q+1),
R is each independently a hydrocarbon group,
L is each independently a hydrolyzable group, a group having a hydrolyzable group, or a hydroxyl group,
mb is a number of 0 or greater,
n is each independently an integer of 0 to 2, and
q is each independently an integer of 1 or greater.

The groups in Formula (1-2) are synonymous with the respective groups in Formula (1-1), and its preferred forms are also the same as those described above.

In Formula (1-2), mb is a number of 0 or greater.

ma is preferably a number of 2 to 600, more preferably a number of 3 to 500, still more preferably a number of 9 to 50, particularly preferably a number of 11 to 30, and most preferably a number of 11 to 25.

Further, the compound (1-2) may be a compound in which: L¹ is an alkylene group; L² is —CH═CH—, —C≡C—, or —C(═CH₂)—; and L³ is an alkylene group. The alkylene groups of L¹ and L³ may be linear or branched, and are preferably linear. The number of carbon atoms of each of L¹ and L³ is preferably 1 to 30, and may be 1 to 25, 1 to 20, 1 to 10, or 5 to 10. For example, each of L¹ and L³ may be an alkylene group having a number of carbon atoms of 1 to 10 or 5 to 10, and L² may be a combination of —CH═CH—, —C≡C—, or —C(═CH₂)—. Note that in the compounds in the above-described preferred ranges and preferred combinations, q may be 1.

The number-average molecular weight (Mn) of a compound according to the present disclosure is preferably 500 to 20,000, more preferably 600 to 18,000, and still more preferably 700 to 15,000.

When Mn is 500 or larger, the abrasion resistance of the surface-treated layer becomes more excellent. When Mn is 20,000 or less, the viscosity can be easily adjusted within an appropriate range and the solubility is improved, so that the handling property during the film formation (i.e., during the deposition of the compound) becomes excellent.

### Composition

It is sufficient if a composition according to the present disclosure contains a compound according to the present disclosure, and its components other than the compound according to the present disclosure are not limited to any particular components.

That is, it is sufficient if the composition according to the present disclosure contains at least one of a compound represented by Formula (1-1) and a compound represented by Formula (1-2). Note that the composition according to the present disclosure may contain both a compound represented by Formula (1-1) and a compound represented by Formula (1-2).

The composition according to the present disclosure preferably contains a compound according to the present disclosure and a liquid medium. In the case where the composition according to the present disclosure contains a liquid medium, it is sufficient if the liquid medium is in a liquid state. That is, the liquid medium may be a solution or a dispersion liquid.

It is sufficient if the composition according to the present disclosure contains a compound according to the present disclosure, and the composition may also contain impurities such as by-products generated in the process for manufacturing the compound according to the present disclosure.

The content of the compound according to the present disclosure is preferably 0.001 to 40 mass %, more preferably 0.01 to 20 mass %, and still more preferably 0.1 to 10 mass % based on the total amount of the composition according to the present disclosure. In the case where the composition according to the present disclosure is used in a wet coating method, the content of the compound according to the present disclosure is preferably 0.01 to 10 mass %, more preferably 0.02 to 5 mass %, still more preferably 0.03 to 3 mass %, and particularly preferably 0.05 to 2 mass % based on the total amount of the composition according to the present disclosure.

The composition according to the present disclosure may contain only one type of liquid medium, or may contain two or more types of liquid mediums.

The liquid medium is preferably an organic solvent.

Examples of organic solvents include compounds consisting solely of hydrogen atoms and carbon atoms, and compounds consisting solely of hydrogen atoms, carbon atoms, and oxygen atoms. Specifically, examples include hydrocarbon-based organic solvents, ketone-based organic solvents, ether-based organic solvents, ester-based organic solvents, glycol-based organic solvents, and alcohol-based organic solvents. Among them, the organic solvent is preferably a hydrocarbon-based organic solvent or an ester-based organic solvent.

Specific examples of hydrocarbon-based organic solvents include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of ketone-based organic solvents include acetone, methyl ethyl ketone, methyl isobutyl ketone, diisobutyl ketone, cyclohexanone, 2-heptanone, 4-heptanone, 3,5,5-trimethyl-2-cyclohexene-1-one, 3,3,5-trimethylcyclohexanone, and isophorone.

Specific examples of ether-based organic solvents include diethyl ether, cyclopentyl methyl ether, tetrahydrofuran, and 1,4-dioxane.

Specific examples of ester-based organic solvents include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, propylene glycol diacetate, dipropylene glycol-methyl ether acetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of glycol-based organic solvents include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, dipropylene glycol monopropyl ether, dipropylene glycol monomethyl ether, tripropylene glycol monobutyl ether tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, diethylene glycol diethyl ether, diethylene glycol dimethyl ether, diethylene glycol dimethyl ether, dipropylene glycol dimethyl ether, diethylene glycol dibutyl ether, tetraethylene glycol dimethyl ether, dipropylene glycol dimethyl ether pentane, triethylene glycol dimethyl ether, and polyethylene glycol dimethyl ether.

Specific examples of alcohol-based organic solvents include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Further, examples of organic solvents include a halogen-based organic solvent, a fluorine-containing organic solvent, a nitrogen-containing compound, a sulfur-containing compound, and a siloxane compound other than the compound according to the present disclosure.

Specific examples of halogen-based organic solvents include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of fluorine-containing organic solvents include polyfluoro aromatic hydrocarbons (e.g., 1,3-bis(trifluoromethyl) benzene); polyfluoro aliphatic hydrocarbons (e.g., C₆F₁₃CH₂CH₃ (e.g., Asahikrin (Registered Trademark) AC-6000 manufactured by AGC Inc.,), 1,1,2,2,3,3,4-heptafluorocyclopentane (e.g., Zeorora (Registered Trademark) H manufactured by Zeon Corporation); hydrofluoroethers (HFE) (e.g., alkyl perfluoroalkyl ethers (perfluoroalkyl group and alkyl group may be linear chain or branched) such as perfluoropropyl methyl ether (C₃F₇OCH₃) (e.g., Novec (Registered Trademark) 7000 manufactured by 3M Japan Limited), perfluorobutyl methyl ether (C₄F₉OCH₃) (e.g., Novec (Registered Trademark) 7100 manufactured by 3M Japan Limited), perfluorobutyl ethyl ether (C₄F₉₀C₂H₅) (e.g., Novec (Registered Trademark) 7200 manufactured by 3M Japan Limited), and perfluorohexyl methyl ether (C₂F₅CF(OCH₃)C₃F₇) (e.g., Novec (Registered Trademark) 7300 manufactured by 3M Japan Limited), and CF₃CH₂OCF₂CHF₂ (e.g., Asahikrin (Registered Trademark) AE-3000 manufactured by AGC Inc.,); and hydrofluoroolefins (HFO) (e.g., 1-chloro-2,3,3-trifluoro-1-propene (HCFO-1233yd) (e.g., Amolea (Registered Trademark) AS-300 manufactured by AGC Inc.,)).

Examples of nitrogen-containing compounds include nitrobenzene, acetonitrile, benzonitrile, N,N-dimethylformamide, N,N-dimethylacetamide, N-methylpyrrolidone, and 1,3-dimethyl-2-imidazolidinone.

Examples of sulfur-containing compounds include carbon disulfide and dimethyl sulfoxide.

Examples of siloxane compounds other than the compound according to the present disclosure include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

The content of the liquid medium is preferably 60 to 99.999 wt. %, more preferably 80 to 99.99 wt. %, and still more preferably 90 to 99.9 wt. % based on the total amount of the composition according to the present disclosure. In the case where the composition according to the present disclosure is used in a wet coating method, the content of the liquid medium is preferably 90 to 99.99 wt. %, more preferably 95 to 99.98 wt. %, still more preferably 97 to 99.97 wt. %, and particularly preferably 98 to 99.95 wt. % based on the total amount of the composition according to the present disclosure.

In addition to the compound according to the present disclosure and the liquid medium, the composition according to the present disclosure may contain other components in a range in which the effects of the present disclosure are not impaired.

Examples of other components include additives, specifically, catalysts, such as acid catalysts and base catalysts, which accelerate the hydrolysis and the condensation reaction of a reactive silyl group.

For example, an arbitrary suitable acid or base, a transition metal (e.g., Ti, Ni, Sn, Zr, Al or B), a sulfur-containing compound having a non-covalent electron pair in the molecular structure, a nitrogen-containing compound (e.g., a sulfoxide compound, an aliphatic amine compound, an aromatic amine compound, a phosphoric acid amide compound, an amide compound, and a urea compound) can be used as the catalyst.

Examples of acid catalysts include acetic acid, formic acid, trifluoroacetic acid, hydrochloric acid, nitric acid, sulfuric acid, phosphoric acid, sulfonic acid, methanesulfonic acid, and p-toluenesulfonic acid.

Further, examples of base catalysts include ammonia, sodium hydroxide, and potassium hydroxide; and organic amines such as triethylamine and diethylamine.

Further, examples of other components also include metal compounds having hydrolyzable groups (hereinafter also referred to as “specific metal compounds”). When the composition according to the present disclosure contains a specific metal compound, the sliding property and the antifouling property of the surface-treated layer can be further improved. Examples of specific metal compounds include a metal compound represented by one of Formulas (M1) to (M3).

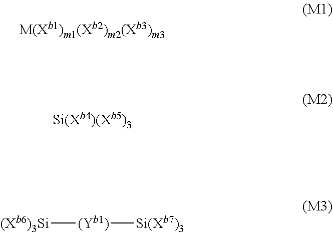

In Formula (M1),
M is a trivalent or tetravalent metal atom,
X^{b1} is each independently a hydrolyzable group,
X^{b2} is each independently a siloxane skeleton-containing group,
X^{b3} is each independently a hydrocarbon chain-containing group,
m1 is an integer of 2 to 4,
m2 and m3 are each independently an integer of 0 to 2, and
when M is a trivalent metal atom, m1+m2+m3 is 3, whereas when M is a tetravalent metal atom, m1+m2+m3 is 4.

In Formula (M2).
X^{b4} is a hydrolyzable silane oligomer residue, and
X^{b5} is each independently a hydrolyzable group or an alkyl group having a number of carbon atoms of 1 to 4.

In Formula (M3),
X^{b6} and X^{b7} are each independently a hydrolyzable group or a hydroxyl group, and
Y^{b1} is a divalent organic group.

The metal represented by M in Formula (M1) includes semimetals such as Si and Ge. M is preferably a trivalent metal or a tetravalent metal, more preferably Al, Fe, In, Hf, Si, Ti, Sn, or Zr, still more preferably Al, Si, Ti, or Zr, and particularly preferably Si.

The hydrolyzable group represented by X^{b1} in Formula (M1) is synonymous with the hydrolyzable group represented by L in the above-shown Formula (1-1), and its preferred forms are also the same as those described above.

The siloxane skeleton-containing group represented by X^{b2} has a siloxane unit (—Si—O—), and may be either a linear chain or a branched chain. The siloxane unit is preferably a dialkylsilyloxy group, and examples include a dimethylsilyloxy group and a diethylsilyloxy group. The number of repetitions of the siloxane unit in the siloxane skeleton-containing group is 1 or greater, preferably 1 to 5, more preferably 1 to 4, and still more preferably 1 to 3.

The siloxane skeleton-containing group may contain a divalent hydrocarbon group in a part of the siloxane skeleton. Specifically, an oxygen atom in a part of the siloxane skeleton may be replaced with a divalent hydrocarbon group. Examples of the aforementioned divalent hydrocarbon group include alkylene groups such as a methylene group, an ethylene group, a propylene group, and a butylene group.

A hydrolyzable group, a hydrocarbon group (preferably an alkyl group), or the like may be bonded to a silicon atom at the end of the siloxane skeleton-containing group.

The number of elements of the siloxane skeleton-containing group is preferably 100 or less, more preferably 50 or less, and still more preferably 30 or less. The upper limit of the number of elements is preferably 10 or larger.

The siloxane skeleton-containing group is preferably a group represented by *—(O—Si(CH₃)₂)ₙCH₃, where n is an integer of 1 to 5 and * indicates a part bonded to an adjacent atom.

The hydrocarbon chain-containing group represented by X^{b3} may be a group consisting solely of a hydrocarbon chain or a group having an etheric oxygen atom between carbon atoms of a hydrocarbon chain. The hydrocarbon chain may be a linear chain or a branched chain, and is preferably a linear chain. The hydrocarbon chain may be a saturated hydrocarbon chain or an unsaturated hydrocarbon chain, and is preferably a saturated hydrocarbon chain. The number of carbon atoms of the hydrocarbon chain-containing group is preferably 1 to 3, more preferably 1 to 2, and still more preferably 1. The hydrocarbon chain-containing group is preferably an alkyl group, and more preferably a methyl group, an ethyl group, or a propyl group.

m1 is preferably 3 or 4.

The compound represented by Formula (Mi) is preferably a compound represented by one of Formulas (M1-1) to (M1-5) in which M is Si, and more preferably a compound represented by Formula (M1-1). The compound represented by Formula (M1-1) is preferably tetraethoxysilane, tetramethoxysilane, or triethoxymethylsilane.

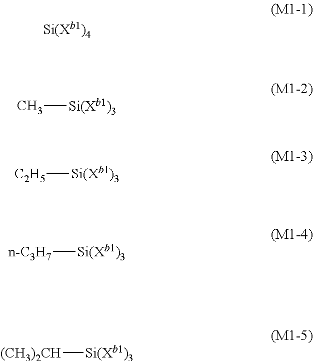

In Formula (M2), the number of silicon atoms contained in the hydrolyzable silane oligomer residue represented by X^{b4} is preferably 3 or greater, more preferably 5 or greater, and still more preferably 7 or greater. The number of silicon atoms is preferably 15 or less, more preferably 13 or less, and still more preferably 10 or less. The hydrolyzable silane oligomer residue may have an alkoxy group that is bonded to a silicon atom.

Examples of the aforementioned alkoxy group include a methoxy group, an ethoxy group, a propoxy group, and a butoxy group. Further, the alkoxy group is preferably a methoxy group or an ethoxy group. The hydrolyzable silane oligomer residue may have one or two or more types of alkoxy groups, and preferably has one type of alkoxy group.

Examples of the hydrolyzable silane oligomer residue include (C₂H₅O)₃Si—(OSi(OC₂H₅)₂)₄O—*. Note that * indicates a part bonded to an adjacent atom.

Examples of the hydrolyzable group represented by X^{b5} in Formula (M2) include those similar to the hydrolyzable group represented by L in the above-shown Formula (1-1), a cyano group, a hydrogen atom, and an allyl group. Further, the hydrolyzable group is preferably an alkoxy group or an isocyanato group. The alkoxy group is preferably an alkoxy group having a number of carbon atoms of 1 to 4.

X^{b5} is preferably a hydrolyzable group.

Examples of the compound represented by Formula (M2) include (H₅C₂O)₃—Si—(OSi(OC₂H₅)₂)₄OC₂H₅.

The compound represented by Formula (M3) is a compound having reactive silyl groups at both ends of a divalent organic group, i.e., is bissilane.

Examples of the hydrolyzable groups represented by X^{b6} and X^{b7} in Formula (M3) include an alkoxy group, an acyloxy group, a ketoxime group, an alkenyloxy group, an amino group, an aminoxy group, an amide group, an isocyanato group, and a halogen atom. Further, the hydrolyzable group is preferably an alkoxy group or an isocyanato group. The alkoxy group is preferably an alkoxy group having a number of carbon atoms of 1 to 4, and still more preferably a methoxy group or an ethoxy group.

In Formula (M3), X^{b6} and X^{b7} may be the same groups as each other or groups different from each other. In view of the availability, X^{b6} and X^{b7} are preferably the same groups as each other.

In Formula (M3), Y^{b1} is a divalent organic group connecting reactive silyl groups at both ends. The number of carbon atoms of Y^{b1} of the divalent organic group is preferably 1 to 8 and more preferably 1 to 3.

Examples of Y^{b1} include an alkylene group, a phenylene group, and an alkylene group having an etheric oxygen atom between carbon atoms. Examples include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃)CH₂OCH₂CH(CH₃)—, and —C₆H₄—.

Examples of the compound represented by Formula (M3) include (CH₃O)₃Si(CH₂)₂Si(OCH₃)₃, (C₂H₅O)₃Si(CH₂)₂Si(OC₂H₅)₃, (OCN)₃Si(CH₂)₂Si(NCO)₃, Cl₃Si(CH₂)₂SiCl₃, (CH₃O)₃Si(CH₂)₆Si(OCH₃)₃, and (C₂H₅O)₃Si(CH₂)₆Si(OC₂H₅)₃.

The content of other components which may be contained in the composition according to the present disclosure is preferably 10 mass % or less and more preferably 1 mass % or less based on the total amount of the composition according to the present disclosure. When the composition according to the present disclosure contains a specific metal compound, the content of the specific metal compound is preferably 0.01 to 30 wt. %, more preferably 0.01 to 10 wt. %, and still more preferably 0.05 to 5 wt. % based on the total amount of the composition according to the present disclosure.

The total content (hereinafter also referred to as “solid content concentration”) of the compound according to the present disclosure and the other components is preferably 0.001 to 40 wt. %, more preferably 0.01 to 20 wt. %, and still more preferably 0.1 to 10 wt. % based on the total amount of the composition according to the present disclosure. The solid content concentration of the composition according to the present disclosure is a value calculated from the mass of the composition before being heated and the mass thereof after being heated in a convection-type dryer at 120° C. for 4 hours.

Since the composition according to the present disclosure contains a liquid medium, it is useful for use in which the composition is used for coating, and can be used as a coating liquid.

In addition to the compound according to the present disclosure and the liquid medium, the composition according to the present disclosure may contain a component(s) other than the compound according to the present disclosure and the liquid medium in a range in which the effects of the present disclosure are not impaired. Examples of the other components include known additives such as acid catalysts and basic catalysts that accelerate the hydrolysis and the condensation reaction of the hydrolyzable silyl group.

The content of the other components in the surface treatment agent disclosed herein is preferably 10 mass % or less and more preferably 1 mass % or less.

Examples of other components include compounds represented by below-shown Formula (2).

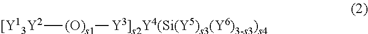

In Formula (2), Y¹ is each independently a hydrocarbon group or a trialkylsilyloxy group,
Y² is Si, Sn, or Ge,
s1 is 0 or 1,
Y³ is each independently an alkylene chain or a polyalkylene oxide chain, or a combination of an alkylene chain and a divalent polysiloxane residue,
Y⁴ is a single bond or a linking group having a valence of s2+s4,
Y⁵ is each independently a hydrocarbon group,
Y⁶ is each independently a hydrolyzable group or a hydroxyl group,
s3 is each independently an integer of 0 to 2,
s2 and s4 are each independently an integer of 1 or greater, and
where Y⁴ does not contain any of —CH═CH—, —C≡C—, and —C(═CH₂)—.

The compound (2) is preferably a compound in which Y³ is an alkylene chain or a polyalkylene oxide chain.

Specific examples of the compound (2) include compounds shown below. α in the formula is preferably 9 to 50, more preferably 11 to 30, and particularly preferably 11 to 25.

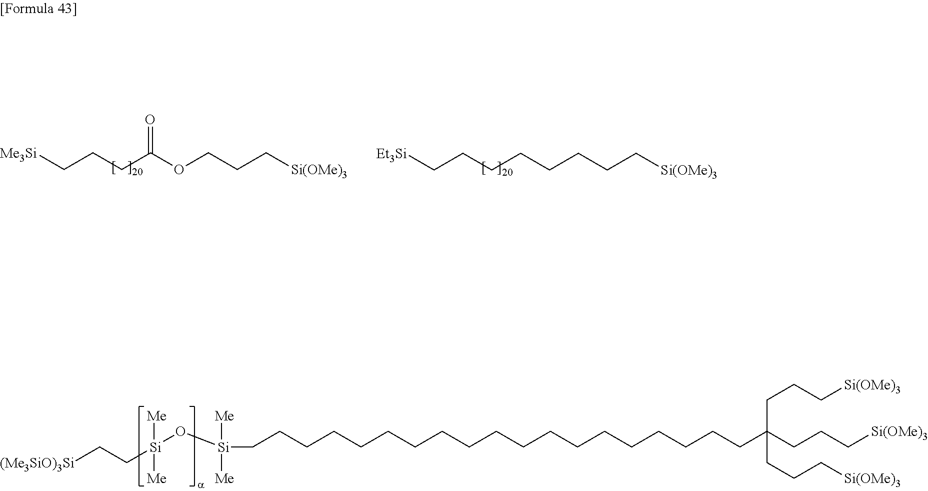

When the other component(s) contained in the surface treatment agent disclosed herein is the compound (2), the content of the compound (2) is preferably 50 mass % or less and more preferably 40 mass % or less.

### [Surface Treatment Agent]

In an embodiment, a surface treatment agent according to the present disclosure contains a compound according to the present disclosure. Further, a surface treatment agent according to the present disclosure may contain a compound according to the present disclosure and a liquid medium. A surface treatment agent according to the present disclosure may be a composition according to the present disclosure. Preferred embodiments of the liquid medium contained in the surface treatment agent according to the present disclosure are similar to those of the liquid medium contained in the composition according to the present disclosure.

It is sufficient if the surface treatment agent according to the present disclosure contains at least one of a compound represented by Formula (1-1) and a compound represented by Formula (1-2). Note that the surface treatment agent according to the present disclosure may comprise both a compound represented by Formula (1-1) and a compound represented by Formula (1-2).

### [Article]

In an embodiment, an article according to the present disclosure includes a substrate and a surface-treated layer which is disposed on the substrate and of which the surface is treated with a surface treatment agent according to the present disclosure.

The surface-treated layer may be formed on a part of the surface of the substrate or over the entire surface of the substrate. The surface-treated layer may be spread in the form of a film on the surface of the substrate or scattered in the form of dots.

In the surface-treated layer, the compound according to the present disclosure is contained therein in a state in which the hydrolysis of some or all of reactive silyl groups has progressed and the dehydration condensation reaction of silanol groups has progressed.

The thickness of the surface-treated layer is preferably 1 to 100 nm and more preferably 1 to 50 nm. When the thickness of the surface-treated layer is 1 nm or larger, the effects of the surface treatment are likely to be obtained satisfactorily. When the thickness of the surface-treated layer is 100 nm or less, the usage efficiency is high. The thickness of the surface-treated layer can be calculated from the oscillation cycle of the interference pattern of the reflected X-ray, which is obtained by an X-ray reflectivity method using an X-ray diffractometer for thin film analysis (Product name: ATX-G, manufactured by Rigaku Corporation).

The type of the substrate is not limited to any particular types, and examples include a substrate which is required to have water repellency. Examples of the substrate include a substrate which may be used while touching it with another article (e.g., a stylus) or a human hand or fingers; a substrate which may be held by a human hand or fingers during the operation; and a substrate which may be placed on another article (e.g., a mounting table).

Examples of the material of the substrate include metals, resins, glass, sapphire, ceramics, semiconductors, stones, fibers, nonwoven fabric, paper, wood, fur, natural leather, artificial leather, ceramics, and composite materials thereof. The glass may be one that is chemically reinforced.

Examples of substrates including building materials, decorative building materials, interior goods, transportation apparatuses (e.g., automobiles), signboards, bulletin boards, drinking containers, tableware, water tanks, ornamental apparatuses (e.g., frames and boxes), laboratory apparatuses, furniture, textile products, and packaging containers; glass or resins used for art, sports, games and the like; glass or resins used for exterior parts (excluding display parts) of apparatuses such as mobile phones (e.g., smartphones), mobile information terminals, game machines, and remote controllers. The shape of the substrate may be plate-like or film-like.

The substrate is preferably a substrate for a touch panel, a substrate for a display, or a lens for eyeglasses, and particularly preferably a substrate for a touch panel. The material of a substrate for a touch panel is preferably glass or a transparent resin.

The substrate may be a substrate of which a surface treatment such as a corona discharge treatment, a plasma treatment, a plasma graft polymerization treatment, or the like has been performed on one or both of the surfaces. The substrate subjected to the surface treatment has a more excellent adhesive property for the surface-treated layer, and the abrasion resistance of the surface-treated layer is further improved. Therefore, it is preferred to perform a surface treatment on the surface of the substrate on the side which is brought into contact with the surface-treated layer. Further, in the case where an underlayer (which will be described later) is provided, the substrate subjected to the surface treatment has a more excellent adhesive property for the underlayer, and the abrasion resistance of the surface-treated layer is further improved. Therefore, in the case where an underlayer is provided, it is preferred to perform a surface treatment on the surface of the substrate on the side which is brought into contact with the underlayer.

The surface-treated layer may be directly disposed on the surface of the substrate, or an underlayer may be provided between the substrate and the surface-treated layer. In order to further improve the water repellency and the abrasion resistance of the surface-treated layer, an article according to the present disclosure preferably includes a substrate, an underlayer disposed on the substrate, and a surface-treated layer which is disposed on the underlayer and of which the surface is treated with a surface treatment agent according to the present disclosure.

The underlayer is preferably a layer comprising an oxide comprising silicon and at least one specific element selected from the group consisting of Group 1 elements, Group 2 elements, Group 4 elements, Group 5 elements, Group 13 elements, and Group 15 elements in the periodic table.

Group 1 elements in the periodic table (hereinafter also referred to simply as “Group 1 elements”) mean lithium, sodium, potassium, rubidium, and cesium. Group 1 elements are preferably lithium, sodium, and potassium, and more preferably sodium and potassium because the surface-treated layer can be formed more uniformly on the underlayer without defects or because variations in the composition of the underlayer among samples are more suppressed. The underlayer may contain two or more Group 1 elements.

Group 2 elements in the periodic table (hereinafter also referred to simply as “Group 2 elements”) mean beryllium, magnesium, calcium, strontium, and barium. Group 2 elements are preferably magnesium, calcium, and barium, and more preferably magnesium and calcium because the surface-treated layer can be formed more uniformly on the underlayer without defects or because variations in the composition of the underlayer among samples are more suppressed. The underlayer may contain two or more Group 2 elements.

Group 4 elements in the periodic table (hereinafter also referred to simply as “Group 4 elements”) mean titanium, zirconium, and hafnium. Group 4 elements are preferably titanium and zirconium, and more preferably titanium because the surface-treated layer can be formed more uniformly on the underlayer without defects or because variations in the composition of the underlayer among samples are more suppressed. The underlayer may contain two or more Group 4 elements.

Group 5 elements in the periodic table (hereinafter also referred to simply as “Group 5 elements”) mean vanadium, niobium, and tantalum. Group 5 elements are particularly preferably vanadium because the abrasion resistance of the surface-treated layer becomes more excellent. The underlayer may contain two or more Group 5 elements.

Group 13 elements in the periodic table (hereinafter also referred to simply as “Group 13 elements”) mean boron, aluminum, gallium, and indium. Group 13 elements are preferably boron, aluminum, and gallium, and more preferably boron and aluminum because the surface-treated layer can be formed more uniformly on the underlayer without defects or because variations in the composition of the underlayer among samples are more suppressed. The underlayer may contain two or more Group 13 elements.

Group 15 elements in the periodic table (hereinafter also referred to simply as “Group 15 elements”) mean nitrogen, phosphorus, arsenic, antimony, and bismuth. Group 15 elements are preferably phosphorus, antimony, and bismuth, and more preferably phosphorus and bismuth because the surface-treated layer can be formed more uniformly on the underlayer without defects or because variations in the composition of the underlayer among samples are more suppressed. The underlayer may contain two or more Group 15 elements.

The specific element contained in the underlayer is preferably a Group 1 element, a Group 2 element, and a Group 13 element, more preferably a Group 1 element and a Group 2 element, and still more preferably a Group 1 element because the abrasion resistance of the surface-treated layer becomes more excellent.

Only one element or two or more elements may be contained as the specific element(s).

The oxide contained in the underlayer may be a mixture of oxides each comprising only one of the aforementioned elements (silicon and specific element) (e.g., a mixture of silicon oxide and an oxide of a specific element), a composite oxide comprising two or more of the aforementioned elements, or a mixture of an oxide comprising only one of the aforementioned elements and a composite oxide.

The ratio of the total molarity of the specific element in the underlayer to the molarity of silicon in the underlayer (specific element/silicon) is preferably 0.02 to 2.90, more preferably 0.10 to 2.00, and still more preferably 0.20 to 1.80 because the abrasion resistance of the surface-treated layer becomes more excellent.

The molarity (mol %) of each element in the underlayer can be measured, for example, by a depth-direction analysis by X-ray photoelectron spectroscopy (XPS) using ion sputtering.

The underlayer may be a single layer or may consist of a plurality of layer. The underlayer may have an uneven surface(s).

The thickness of the underlayer is preferably 1 to 100 nm, more preferably 1 to 50 nm, and still more preferably 2 to 20 nm. When the thickness of the underlayer is equal to or larger than the aforementioned lower limit value, the adhesive property of the surface-treated layer by the underlayer is further improved, so that the abrasion resistance of the surface-treated layer becomes more excellent. When the thickness of the underlayer is equal to or less than the aforementioned upper limit value, the abrasion resistance of the underlayer itself becomes excellent.

The thickness of the underlayer is measured by observing the cross section of the underlayer by a transmission electron microscope (TEM).

The underlayer can be formed, for example, by a vapor-deposition method using a vapor-deposition material or a wet coating method.

The vapor-deposition material used in the vapor-deposition method preferably contains an oxide comprising silicon and a specific element.

Specific examples of the form of the vapor-deposition material include a powder, a molten material, a sintered compact, granules, and a crushed material. Further, a molten material, a sintered compact, and granules are preferred in view of the handling property.

Note that the molten material means a solid material obtained by melting a powder of a vapor-deposition material at a high temperature, and then cooling and solidifying the molten vapor-deposition material.

The sintered compact means a solid material obtained by firing a powder of a vapor-deposition material. Further, if necessary, instead of the powder of the vapor-deposition material, a molded compact formed by pressing the powder may be used. The granules means a solid material obtained by mixing and kneading a powder of a vapor-deposition material and a liquid medium (e.g., water or an organic solvent) and thereby obtaining particles thereof, and then drying the obtained particles.

The vapor-deposition material can be manufactured, for example, by the following methods.
A method in which a powder of a vapor-deposition material is obtained by mixing a powder of silicon oxide with a powder of an oxide of a specific element.
A method in which granules of a vapor-deposition material is obtained by, after obtaining particles by mixing and kneading a powder of the aforementioned vapor-deposition material and water, drying the obtained particles.
A method in which a sintered compact is obtained by drying a mixture obtained by mixing a powder comprising silicon (e.g., a powder made of silicon oxide, silica sand, or silica gel), a powder comprising a specific element (e.g., a powder of an oxide of a specific element, a carbonate, a sulfate, a nitrate, an oxalate, or a hydroxide), and water, and then firing the dried mixture or a molded article obtained by press-molding the dried mixture.
A method in which a molten material is obtained by melting a mixture obtained by mixing a powder comprising silicon (e.g., a powder made of silicon oxide, silica sand, or silica gel), a powder comprising a specific element (e.g., a powder of an oxide of a specific element, a carbonate, a sulfate, a nitrate, an oxalate, or a hydroxide), and water at a high temperature, and then cooling and solidifying the molten substance.

Specific examples of the vapor-deposition method using a vapor-deposition material include a vacuum vapor-deposition method. The vacuum vapor-deposition method is a method in which a vapor-deposition material is evaporated in a vacuum chamber and deposited on the surface of a substrate.

The temperature during the vapor-deposition (e.g., in the case where a vacuum deposition apparatus is used, the temperature of a boat in which the deposition material is disposed) is preferably 100 to 3,000° C. and more preferably 500 to 3,000° C.

The pressure during the vapor-deposition (e.g., in the case where a vacuum deposition apparatus is used, the pressure in a chamber in which the deposition material is disposed) is preferably 1 Pa or lower and more preferably 0.1 Pa or lower.

When an underlayer is formed by using a vapor-deposition material, one vapor-deposition material may be used, or two or more vapor-deposition materials comprising different elements may be used.

Specific examples of the method for evaporating a vapor-deposition material include a resistive heating method in which a vapor-deposition material is melted and evaporated on a resistive heating boat made of a high melting-point metal, and an electron gun method in which a vapor-deposition material is irradiated with an electron beam and thereby directly heated, so that its surface is melted and evaporated.

As the method for evaporating a vapor-deposition material, the electron gun method is preferred because since the material can be locally heated, even a material having a high melting point can be evaporated, and since an area that is not irradiated with the electron beam is kept at a low temperature, there is no risk of reaction with the container nor risk of contamination by impurities.

As the method for evaporating a vapor-deposition material, a plurality of boats may be used, or the whole vapor-deposition materials may be put in a single boat. The vapor-deposition method may be co-vapor deposition or alternating vapor deposition. Specific examples include an example in which silica and a specific source are mixed and used in the same boat, an example in which co-vapor deposition is performed in a state in which silica and a specific element source put in separate boats, and an example in which alternating vapor deposition is performed in a similar manner, i.e., in a state in which silica and a specific element source are put in separate boats. The conditions for the vapor deposition, the order, and the like are selected as appropriate according to the structure of the underlayer.

In the wet coating method, it is preferred to form an underlayer on a substrate by a wet coating method using a coating liquid comprising a compound comprising silicon, a compound comprising a specific element, and a liquid medium.

Specific examples of silicon compounds include silicon oxide, silicic acid, partial condensate of silicic acid, alkoxysilane, and partial hydrolysis condensate of alkoxysilane.

Specific examples of compounds comprising a specific element include oxides of the specific element, alkoxides of the specific element, carbonates of the specific element, sulfates of the specific element, nitrates of the specific element, oxalates of the specific element, and hydroxides of the specific element.

Examples of liquid mediums include those similar to liquid mediums contained in the composition according to the present disclosure.

The content of the liquid medium is preferably 0.01 to 20 mass % and more preferably 0.1 to 10 mass % based on the total amount of the coating liquid used for the formation of the underlayer.

Specific examples of the wet coating method for forming an underlayer include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

After the wet-coated with the coating liquid, the coating is preferably dried. The drying temperature of the coating is preferably 20 to 200° C. and more preferably 80 to 160° C.

The article according to the present disclosure may be an optical material including a surface-treated layer as the outermost layer.

Examples of preferred optical materials include a wide variety of optical materials in addition to optical materials related to displays or the like.

Examples of optical materials include a cathode ray tube (CRT; e.g., a computer monitor), a display such as a liquid crystal display, a plasma display, an organic EL display, an inorganic thin film EL dot matrix display, a rear projection-type display, a vacuum fluorescent display (VFD), and a field emission display (FED), a protective plate for such a display, and those in which an antireflection film treatment is performed on their surfaces.

The article according to the present disclosure is preferably an optical member. Examples of optical members include a car navigation system, a mobile phone, a smartphone, a digital camera, a digital video camera, a PDA, a portable audio player, a car audio system, a game apparatus, a lens for eyeglasses, a camera lens, a lens filter, sunglasses, a medical apparatus such as a gastroscope, a copying machine, a PC, a display (e.g., a liquid crystal display, an organic EL display, a plasma display, and a touch panel display), a touch panel, a protective film, and an antireflection film.

Further, examples of optical members include a front protective plate for a display such as a PDP and an LCD, an antireflection plate, a polarizing plate, and an antiglare plate; a disk surface of an optical disk such as a Blu-ray (Blu-ray (Registered Trademark)) disk, a DVD disk, a CD-R, and an MO; an optical fiber; and a display surface of a clock or a watch.

In particular, the article according to the present disclosure is preferably a display or a touch panel.

The article according to the present disclosure may be a medical apparatus or a medical material. Further, the article according to the present disclosure may also be an automobile interior or exterior member. Examples of exterior members include a window, a light cover, and an external camera cover. Examples of interior members include an instrument panel cover, a navigation system touch panel, and a decorative interior member.

When the article according to the present disclosure is an optical member, the material constituting the surface of the substrate is a material for an optical member, e.g., glass or transparent plastic. Further, when the article according to the present disclosure is an optical member, a functional layer such as a hard coat layer or an antireflection layer may be formed on the surface (outermost layer) of the substrate. The antireflection layer may be either a single-layer antireflection layer or a multi-layer antireflection layer.

Examples of inorganic substances that can be used for the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. These inorganic substances may be used alone or in combination (e.g., as a mixture) of two or more of them. In the case of the multi-layer antireflection layer, it is preferred to use SiO₂ and/or SiO in the outermost layer. When the article according to the present disclosure is an optical glass component for a touch panel, a thin film using a transparent electrode, e.g., indium tin oxide (ITO), indium zinc oxide, or the like, may be provided on a part of the surface of the substrate (glass). Further, the substrate may also include an insulating layer, an adhesive layer, a protective layer, a decorative frame layer (I-CON), an atomization film layer, a hard coating film layer, a polarizing film, a phase difference film, a liquid crystal display module, or the like according to its specific specifications.

### [Method for Manufacturing Article]

A method for manufacturing an article according to the present disclosure is, for example, a method for manufacturing an article including a surface-treated layer formed on a substrate by performing a surface treatment on the substrate by using a surface treatment agent according to the present disclosure. Examples of surface treatments include a dry coating method and a wet coating method.

Examples of dry coating methods include techniques such as vacuum vapor deposition, CVD, and sputtering. As the dry coating method, a vacuum vapor-deposition method is preferred in order to suppress the decomposition of the compound and in view of the simplicity of the apparatus. During the vacuum deposition, a pellet-like substance obtained by impregnating a porous material made of a metal such as iron or steel with a compound according to the present disclosure may be used. A pellet-like substance, which is obtained by impregnating a porous material made of a metal such as iron or steel with a composition comprising a compound according to the present disclosure and a liquid medium, and drying the liquid medium, may be used.

Examples of wet coating methods include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

In order to improve the abrasion resistance of the surface-treated layer, when necessary, an operation for accelerating the reaction between the compound according to the present disclosure and the substrate may be performed. Examples of such operations include heating, humidification, and irradiation with light.

For example, it is possible to accelerate, by heating a substrate on which a surface-treated layer is formed in an atmosphere comprising moisture, the reaction such as a hydrolysis reaction of a hydrolyzable group, a reaction between a hydroxyl group or the like and a silanol group on the surface of the substrate, and formation of a siloxane bond by a condensation reaction of a silanol group.

After the surface treatment, compounds which are contained in the surface-treated layer and are not chemically bonded to other compounds nor the substrate may be removed as required. Examples of removal methods include a method in which a solvent is poured over the surface-treated layer, and a method in which the surface-treated layer or the like is wiped with a cloth impregnated with a solvent.

### EXAMPLES

The present invention will be described hereinafter in a more detailed manner by using examples, but the present invention is not limited to these examples.

### Compound (A)

### Synthesis of Compound (A1)

THF (Tetrahydrofuran, 30 mL), cesium fluoride (0.80 g), and bis(pentafluorophenyl) carbonate (7.4 g) were added to 10-undecinic-acid (3.0 g), and the mixture was stirred at 25° C. for 16 hours, so that a reaction solution was obtained. An organic phase was extracted from the reaction solution by further adding water and hexane to the reaction solution. Then, 3.5 g of a compound (A1) was obtained by removing the solvent and low-boiling components by distillation under a reduced pressure and performing flash column chromatography (developing solvent: hexane/ethyl acetate) using silica gel. The structure of the compound (A1) was confirmed from NMR data shown below.

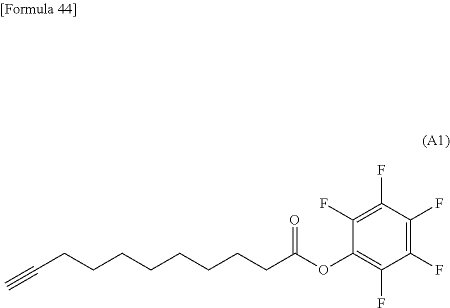 [SMILES: C#CCCCCCCCCC(=O)Oc1c(F)c(F)c(F)c(F)c1F]

¹H-NMR (400 MHz, CDCl₃): δ2.66 (t, J=7.4 Hz, 2H), 2.19 (td, J=7.0, 2.7 Hz, 2H), 1.99-1.23 (m, 13H).

### Synthesis of Compound (A2)

THF (101 g) was added to hexamethylcyclotrisiloxane (76 g), and the mixture was stirred until the THF was dissolved. Then, a solution in which lithium salt of trimethylsilanol (5.1 g) was suspended in THF (20 g) was added to the resultant solution, and the mixture was stirred at 25° C. for 2 hours. After that, chlorodimethylsilane (10.5 g) was added to the resultant solution, and the mixture was stirred at 25° C. for 1 hour. After the extraction was performed by adding hexane and water, the solvent and low-boiling components were removed by distillation under a reduced pressure. Then, 25 g of a compound (A2) was obtained by performing flash column chromatography (developing solvent: hexane/dichloromethane) using silica gel.

The average value of ma in the compound (A2) was 17. The structure of the compound (A2) was confirmed from NMR data shown below.

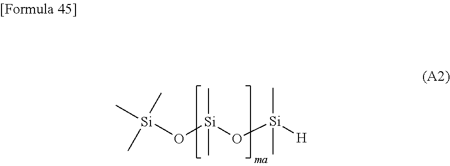

¹H-NMR (400 MHz, CDCl₃): δ4.63 (hept, J=2.8 Hz, 1H), 0.21-0.08 (m, 6H), 0.17-0.07 (m, 111H).

### Synthesis of Compound (A3) and Compound (A4)

Dichloromethane (20 g) and the compound (A²) (13 g) were added to the compound (A1) (3.5 g), and the mixture was stirred until it became homogeneous. Then, a toluene solution of a platinum/1, 3-divinyl-1, 1, 3, 3-tetramethyldisiloxane complex (platinum content: 3 mass %, 4.1 mg) was added to the resultant solution, and the mixture was stirred at 25° C. for 2 hours. After the solvent and low-boiling components were removed by distillation under a reduced pressure, 2.5 g of a compound (A3) and 0.8 g of a compound (A4) were obtained by performing flash column chromatography (developing solvent: hexane/dichloromethane) using silica gel. The average value of ma in the compound (A3) was 17. Further, the average value of ma in the compound (A4) was 17. The structures of the compound (A3) and compound (A4) were confirmed from NMR data shown below.

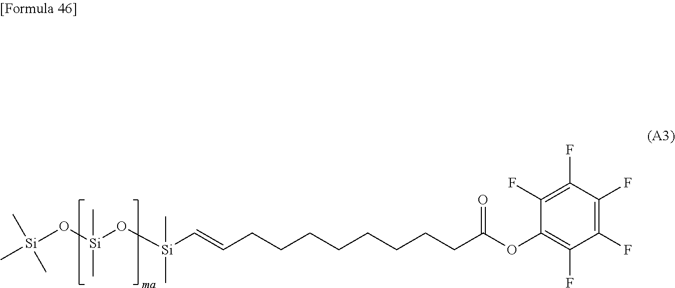

¹H-NMR (400 MHz, CDCl₃): δ 6.03(dt, J=18.6, 6.2 Hz, 1H), 5.51(dt, J=18.6, 1.5 Hz, 1H), 2.56 (t, J=7.4 Hz, 2H), 2.11-1.00 (m, 14H), 0.22-0.20 (m, 111H).

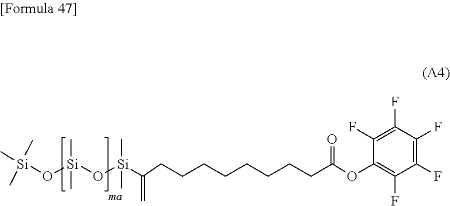

¹H-NMR (400 MHz, CDCl₃): δ5.50-5.26 (m, 2H), 2.56 (t, J=7.5 Hz, 2H), 2.12-0.90 (m, 14H), 0.22-0.20 (m, 111H).

### Synthesis of Compound (A5)

11-bromo-1-undecene (11.8 g), potassium carbonate (11.2 g), and dimethylformamide (50 g) were added to methyl cyanoacetate (2.1 g), and the mixture was stirred at 85° C. overnight. After the resultant solution was cooled to 25° C., an aqueous hydrochloric acid solution was added to the solution, and the extraction was performed with dichloromethane. 9.6 g of a compound (A51) shown below was obtained by removing the solvent by distillation. The structure of the compound (A51) was confirmed from NMR data shown below.

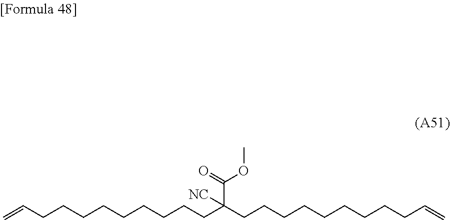 [SMILES: C=CCCCCCCCCCC(C#N)(CCCCCCCCCC=C)C(=O)OC]

¹H-NMR (400 MHz, CDCl₃): δ5.92-5.74 (m, 2H), 5.13-4.90 (m, 4H), 3.80 (s, 3H), 2.20-1.90 (m, 4H), 1.90-1.00 (m, 32H).

Dimethyl sulfoxide (30 g) was added to the compound (A51) (9.5 g), and after stirring the mixture, water (5 g) and lithium chloride (3.2 g) were added to the resultant solution. The temperature of the mixture was raised to 180° C., and the mixture was heated and stirred overnight. After lowering the temperature of the resultant solution to ° C., the extraction was performed with dichloromethane. Then, 7.4 g of a compound (A52) was obtained by performing flash column chromatography (developing solvent: ethyl acetate/hexane) using silica gel. The structure of the compound (A52) was confirmed from NMR data shown below.

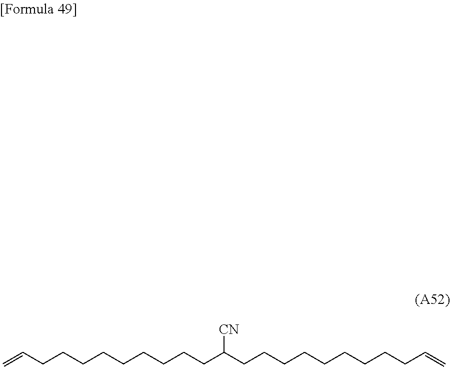 [SMILES: C=CCCCCCCCCCC(C#N)CCCCCCCCCC=C]

¹H-NMR (400 MHz, CDCl₃): δ5.92-5.74 (m, 2H), 5.13-4.90 (m, 4H), 2.62-2.41 (m, 1H), 2.20-1.95 (m, 4H), 1.90-1.00 (m, 32H).

The compound (A52) (5.4 g) was dissolved in THF, and the solution was cooled to 0° C. A THF solution of lithium aluminum hydride (27 mL, 27 mmol) was added to the solution, and the mixture was stirred. Water and 15 mass % of an aqueous sodium hydroxide solution were added to the resultant solution, and after stirring the mixture at 25° C., the resultant solution was diluted with dichloromethane. After filtration, the solvent was removed by distillation. Then, 4.9 g of a compound (A5) shown below was obtained by performing flash column chromatography (developing solvent: methanol) using silica gel. The structure of the compound (A5) was confirmed from NMR data shown below.

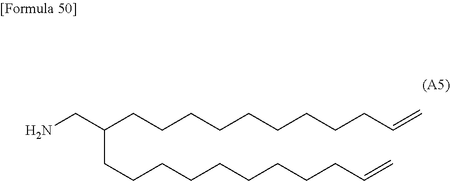 [SMILES: C=CCCCCCCCCCC(CN)CCCCCCCCCC=C]

¹H-NMR (400 MHz, CDCl₃): δ5.92-5.74 (m, 2H), 5.13-4.90 (m, 4H), 2.75-2.55 (m, 2H), 2.20-1.95 (m, 4H), 1.90-1.00 (m, 33H).

### Synthesis of Compound (A6)

After dichloromethane (10 g) was added to the compound (A5) (0.42 g) and the mixture was made homogeneous, the compound (A3) (1.0 g) was added to the mixture, and the mixture was stirred at 25° C. for 12 hours. After removing the solvent and low-boiling components by distillation, 0.80 g of a compound (A6) was obtained by performing flash column chromatography (developing solvent: hexane/ethyl acetate) using silica gel. The average value of ma in the compound (A6) was 17. The structure of the compound (A6) was confirmed from NMR data shown below.

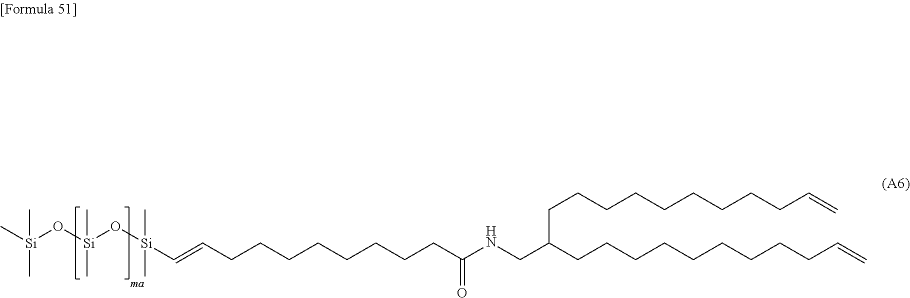

¹H-NMR (400 MHz, CDCl₃): δ6.14-4.65 (m, 9H), 3.11 (t, J=6.0 Hz, 2H), 2.30-0.93 (m, 53H), 0.22-0.20 (m, 111H).

### Synthesis of Compound (A)

Dichloromethane (10 g) was added to the compound (A6) (0.80 g) and the mixture was made homogeneous. Then, a toluene solution of a platinum/1, 3-divinyl-1, 1, 3, 3-tetramethyldisiloxane complex (platinum content: 3 mass %, 4.1 mg), aniline (2.6 mg), and trimethoxysilane (0.20 g) were added to the mixture, and the mixture was stirred at 50° C. for 2 hours. 0.85 g of a compound (A) was obtained by removing the solvent by distillation under a reduced pressure. The average value of ma in the compound (A) was 17. The structure of the compound (A) was confirmed from NMR data shown below.

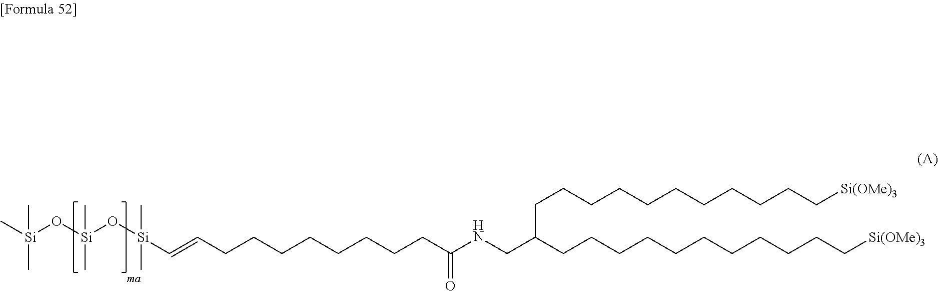

¹H-NMR (400 MHz, CDCl₃): δ6.16-5.43 (m, 2H), 3.49 (s, 18H), 3.11 (t, J=6.0 Hz, 2H), 2.32-0.31 (m, 61H), 0.22-0.20 (m, 111H).

### Compound (B)

### Synthesis of Compound (B1)

Dichloromethane (10 g) was added to the compound (A4) (0.8 g) and the mixture was made homogeneous. Then, the compound (A5) (0.31 g) was added to the mixture, and the mixture was stirred at 25° C. for 12 hours. After removing the solvent and low-boiling components by distillation, 0.67 g of a compound (B1) was obtained by performing flash column chromatography (developing solvent: hexane/ethyl acetate) using silica gel. The average value of ma in the compound (B1) was 17. The structure of the compound (B1) was confirmed from NMR data shown below.

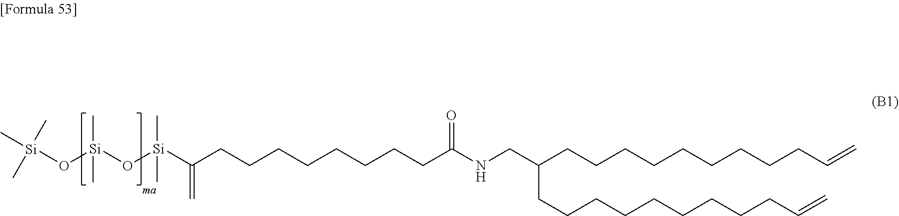

¹H-NMR (400 MHz, CDCl₃): δ5.91-4.68 (m, 9H), 3.04 (dd, J=6.0, 5.3 Hz, 2H), 2.55-0.97 (m, 53H), 0.22-0.20 (m, 111H).

### Synthesis of Compound (B)

Dichloromethane (10 g) was added to the compound (B1) (0.67 g) and the mixture was made homogeneous. Then, a toluene solution of a platinum/1, 3-divinyl-1, 1, 3, 3-tetramethyldisiloxane complex (platinum content: 3 mass %, 4.1 mg), aniline (2.6 mg), and trimethoxysilane (0.20 g) were added to the mixture, and the mixture was stirred at 50° C. for 2 hours. 0.71 g of a compound (B) was obtained by removing the solvent and low-boiling components by distillation under a reduced pressure. The average value of ma in the compound (B) was 17. The structure of the compound (B) was confirmed from NMR data shown below.

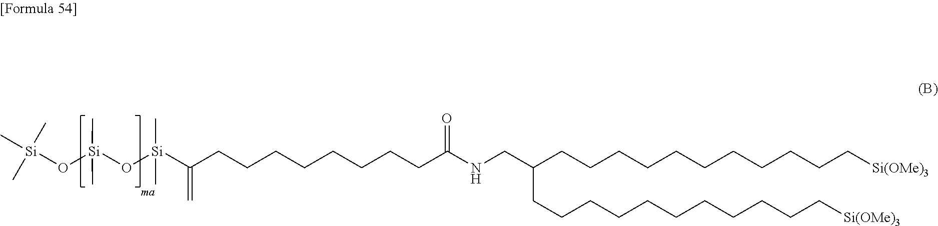

¹H-NMR (400 MHz, CDCl₃): δ5.91-4.99 (m, 2H), 3.49 (s, 18H), 3.04 (t, J=6.0 Hz, 2H), 2.32-0.31 (m, 61H), 0.22-0.20 (m, 111H).

### Compound (C)

### Synthesis of Compound (C1)

After THF (200 g) was added to 1-hexene-5-yne (8 g), and the mixture was stirred until it became homogeneous, the mixture was cooled to 0° C. After that, butyllithium (15 mass % hexane solution, 1.6 mol/L) (50 mL) was added to the mixture, and the mixture was stirred at 0° C. for 30 minutes. After that, hexamethylcyclotrisiloxane (120 g) was added to the mixture, and the mixture was stirred at 25° C. for 16 hours. After that, chlorotrimethylsilane (20 g) was added to the mixture, and the mixture was stirred at 25° C. for 1 hour. After extracting an organic phase from the solution by adding water and hexane to the solution, the solvent and low-boiling components were removed by distillation. Then, 23 g of a compound (C1) was obtained by performing flash column chromatography (developing solvent: hexane/dichloromethane) using silica gel. The average value of ma in the compound (C1) was 17. The structure of the compound (C1) was confirmed from NMR data shown below.

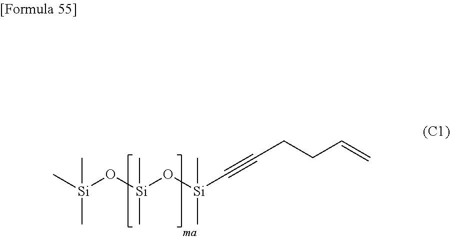

¹H-NMR (400 MHz, CDCl₃): δ5.92-5.57 (m, 1H), 5.24-4.83 (m, 2H), 2.46-1.72 (m, 4H), 0.14-0.03 (m, 111H).

### Synthesis of Compound (C)

Dichloromethane (10 g) was added to the compound (C1) (0.82 g) and the mixture was made homogeneous. Then, a toluene solution of a platinum/1, 3-divinyl-1, 1, 3, 3-tetramethyldisiloxane complex (platinum content: 3 mass %, 4.1 mg), aniline (2.6 mg), and trimethoxysilane (0.07 g) were added to the mixture, and the mixture was stirred at 50° C. for 2 hours. 0.85 g of a product mainly made of the compound (C) was obtained by removing the solvent and low-boiling components by distillation under a reduced pressure. The average value of ma in the compound (C) was 17. The structure of the compound (C) was confirmed from NMR data shown below.

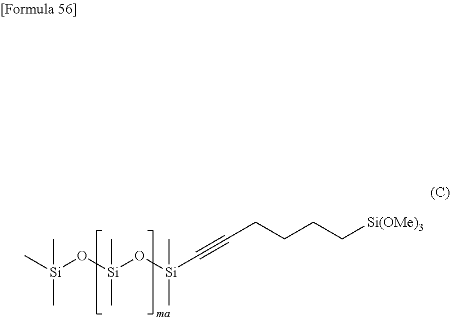

¹H-NMR (400 MHz, CDCl₃): δ3.58 (s, 9H), 2.37-2.10 (m, 2H), 1.63-1.29 (m, 4H), 0.80-0.57 (m, 2H), 0.17-0.05 (m, 111H).

### Compound (D)

### Synthesis of Compound (D1)

Dichloromethane (20 g) and 1, 1, 1, 3, 3-pentamethyldisiloxane (2.3 g) were added to 1-bromo-1-undecine (2.5 g), and the mixture was stirred until it became homogeneous. Then, a toluene solution of a platinum/1, 3-divinyl-1, 1, 3, 3-tetramethyldisiloxane complex (platinum content: 3 mass %, 4.1 mg) was added to the resultant solution, and the mixture was stirred at 25° C. for 2 hours. 3.0 g of a compound (D1) was obtained by removing the solvent and low-boiling components by distillation under a reduced pressure and performing flash column chromatography (developing solvent: hexane/dichloromethane) using silica gel. The structure of the compound (D1) was confirmed from NMR data shown below.

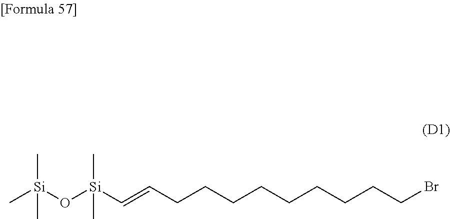 [SMILES: C[Si](C)(C)O[Si](C)(C)/C=C/CCCCCCCCCBr]

¹H-NMR (400 MHz, CDCl₃): δ6.17-5.61 (m, 2H), 3.42 (t, J=4.7 Hz, 2H), 2.15 (tdd, J=7.5, 6.2, 1.0 Hz, 2H), 1.84-1.10 (m, 14H), 0.21--0.15 (m, 15H).

### Synthesis of Compound (D2)

THF (40 g) and magnesium (0.9 g) were added to 18-bromo-1-octadecene (10 g), and the mixture was stirred at 60° C. for 2 hours. 50 g of a compound (D2) was obtained by filtering the reaction solution. It was confirmed that the concentration of the product was 0.4 mol/L by titration using 1, 10 phenanthroline.

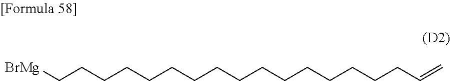

### Synthesis of Compound (D3)

THF (10 g), the compound (D2) (0.4 mol/L) (10 mL), and copper (II) chloride (0.05 g) were added to the compound (D1) (1 g), and the mixture was stirred at 60° C. for 24 hours. After extracting an organic phase from the resultant solution by adding hydrochloric acid and hexane to the solution, low-boiling components were removed by distillation under a reduced pressure. Then, 0.2 g of a compound (D3) was obtained by performing flash column chromatography (developing solvent: hexane/dichloromethane) using 10% silver nitrate silica gel. The structure of the compound (D3) was confirmed from NMR data shown below.

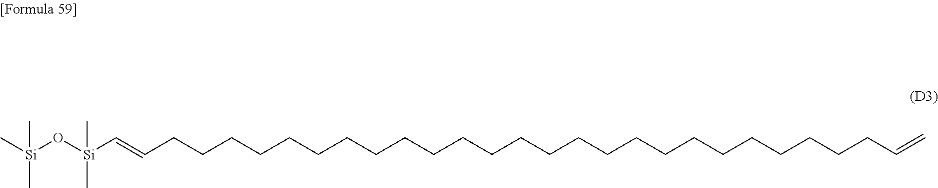 [SMILES: C=CCCCCCCCCCCCCCCCCCCCCCCCCC/C=C/[Si](C)(C)O[Si](C)(C)C]

¹H-NMR (400 MHz, CDCl₃): δ6.15-4.68 (m, 5H), 2.28-1.84 (m, 4H), 1.54-1.12 (m, 46H), 0.21--0.15 (m, 15H).

### Synthesis of Compound (D)

Dichloromethane (10 g) was added to the compound (D3) (0.2 g) and the mixture was made homogeneous. Then, a toluene solution of a platinum/1, 3-divinyl-1, 1, 3, 3-tetramethyldisiloxane complex (platinum content: 3 mass %, 4.1 mg), aniline (2.6 mg), and trimethoxysilane (0.3 g) were added to the mixture, and the mixture was stirred at 50° C. for 2 hours. 0.2 g of a compound (D) was obtained by removing the solvent and low-boiling components by distillation under a reduced pressure. The structure of the compound (D) was confirmed from NMR data shown below.

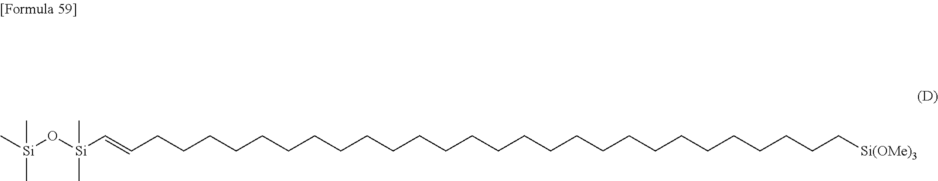

¹H-NMR (400 MHz, CDCl₃): δ6.21-5.30 (m, 2H), 3.58 (s, 9H), 2.15 (tdd, J=7.5, 6.2, 1.0 Hz, 2H), 1.59-1.02 (m, 50H), 0.65 (t, J=9.2 Hz, 2H), 0.21--0.15 (m, 15H).

### Compound (E)

### Synthesis of Compound (E1)

Dichloromethane (20 g) and 1, 1, 3, 3, 5, 5, 7, 7, 9, 9, 11, 11-dodecamethylhexasiloxane (3.0 g) were added to 1-bromo-1-undecine (7.0 g), and the mixture was stirred until it became homogeneous. Then, a toluene solution of a platinum/1, 3-divinyl-1, 1, 3, 3-tetramethyldisiloxane complex (platinum content: 3 mass %, 4.1 mg) was added to the mixture, and the mixture was stirred at 25° C. for 2 hours. 1.2 g of a compound (E1) was obtained by removing the solvent and low-boiling components by distillation under a reduced pressure and performing flash column chromatography (developing solvent: hexane/dichloromethane) using silica gel. The structure of the compound (E1) was confirmed from NMR data shown below.

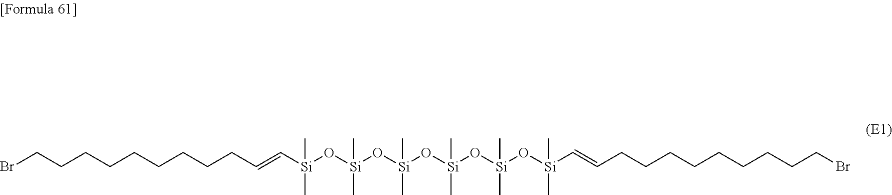 [SMILES: C[Si](C)(/C=C/CCCCCCCCCBr)O[Si](C)(C)O[Si](C)(C)O[Si](C)(C)O[Si](C)(C)O[Si](C)(C)/C=C/CCCCCCCCCBr]

¹H-NMR (400 MHz, CDCl₃): δ6.26-5.48 (m, 4H), 3.42 (t, J=4.7 Hz, 4H), 2.15 (tdd, J=7.6, 6.3, 1.0 Hz, 4H), 1.82-1.13 (m, 28H), 0.34--0.26 (m, 36H).

### Synthesis of Compound (E2)

THF (10 g) and allyl magnesium chloride (11% THF solution, 1.0 mol/L) (10 mL) were added to the compound (E1) (1 g), and the mixture was stirred at 60° C. for 24 hours. After extracting an organic phase from the resultant solution by adding hydrochloric acid and hexane to the solution, low-boiling components were removed by distillation under a reduced pressure. Then, 0.7 g of a compound (E2) was obtained by performing flash column chromatography (developing solvent: hexane/ethyl acetate) using 10% silver nitrate silica gel. The structure of the compound (E2) was confirmed from NMR data shown below.

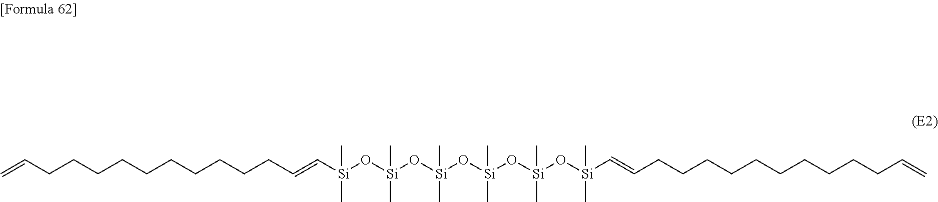 [SMILES: C=CCCCCCCCCCC/C=C/[Si](C)(C)O[Si](C)(C)O[Si](C)(C)O[Si](C)(C)O[Si](C)(C)O[Si](C)(C)/C=C/CCCCCCCCCCC=C]

¹H-NMR (400 MHz, CDCl₃): δ6.28-4.69 (m, 10H), 2.27-1.82 (m, 8H), 1.49-1.05 (m, 32H), 0.33--0.30 (m, 36H).

### Synthesis of Compound (E)

Dichloromethane (10 g) was added to the compound (E2) (0.4 g) and the mixture was made homogeneous. Then, a toluene solution of a platinum/1, 3-divinyl-1, 1, 3, 3-tetramethyldisiloxane complex (platinum content: 3 mass %, 4.1 mg), aniline (2.6 mg), and trimethoxysilane (0.5 g) were added to the mixture, and the mixture was stirred at 35° C. for 2 hours. 0.5 g of a compound (E) was obtained by removing the solvent and low-boiling components by distillation under a reduced pressure. The structure of the compound (E) was confirmed from NMR data shown below.

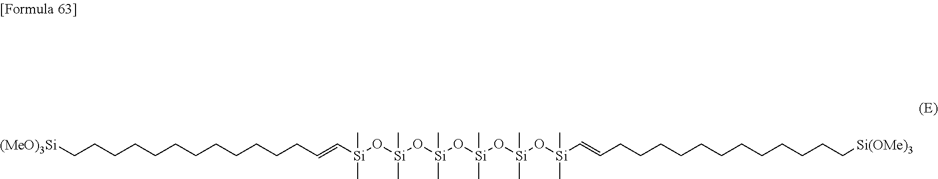

¹H-NMR (400 MHz, CDCl₃): δ6.32-5.49 (m, 4H), 3.58 (s, 18H), 2.15 (tdd, J=7.6, 6.3, 1.0 Hz, 4H), 1.64-0.95 (m, 40H), 0.65 (t, J=9.2 Hz, 4H), 0.31--0.20 (m, 36H).

### Compound (F)

### Synthesis of Compound (F1)

Dichloromethane (20 g) and a Grubbs catalyst (Registered Trademark) M204 (0.1 g) were added to 9-bromo-1-nonene (5.0 g), and the mixture was stirred at 35° C. for 24 hours. After removing the solvent and low-boiling components by distillation under a reduced pressure, 2.5 g of a compound (F1) was obtained by performing flash column chromatography (developing solvent: hexane/dichloromethane) using silica gel. The structure of the compound (F1) was confirmed from NMR data shown below.

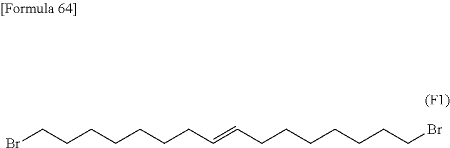 [SMILES: BrCCCCCCC/C=C/CCCCCCCBr]

¹H-NMR (400 MHz, CDCl₃): δ5.50-5.21 (m, 2H), 3.41 (t, J=6.9 Hz, 4H), 2.09-1.70 (m, 8H), 1.53-1.00 (m, 16H).

### Synthesis of Compound (F2)

THF (10 g) and allyl magnesium chloride (11% THF solution, 1.0 mol/L) (10 mL) were added to the compound (F1) (2 g), and the mixture was stirred at 60° C. for 24 hours. After extracting an organic phase from the resultant solution by adding hydrochloric acid and hexane to the solution, low-boiling components were removed by distillation under a reduced pressure. Then, 1.2 g of a compound (F2) was obtained by performing flash column chromatography (developing solvent: hexane/ethyl acetate) using silica gel. The structure of the compound (F2) was confirmed from NMR data shown below.

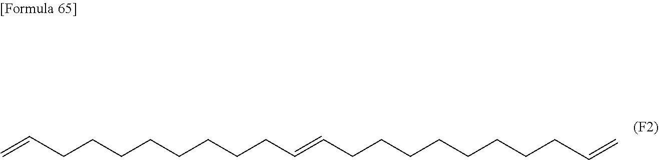 [SMILES: C=CCCCCCCCC/C=C/CCCCCCCCC=C]

¹H-NMR (400 MHz, CDCl₃): δ5.81 (ddt, J=16.9, 10.2, 6.7 Hz, 2H), 5.48-5.26 (m, 2H), 5.09-4.79 (m, 4H), 2.19-1.74 (m, 8H), 1.48-0.98 (m, 24H).

### Synthesis of Compound (F)

Dichloromethane (10 g), trimethoxysilane (1.0 g), and 1, 1, 1, 3, 3-pentamethyldisiloxane (1.0 g) were added to the compound (F₂) (1.2 g) and the mixture was made homogeneous. Then, a toluene solution of a platinum/1, 3-divinyl-1, 1, 3, 3-tetramethyldisiloxane complex (platinum content: 3 mass %, 4.1 mg) and aniline (2.6 mg) were added to the mixture, and the mixture was stirred at 35° C. for 3 hours. 0.5 g of a compound (F) was obtained by removing the solvent and low-boiling components by distillation under a reduced pressure and performing flash column chromatography (developing solvent: hexane/ethyl acetate) using silica gel. The structure of the compound (F) was confirmed from NMR data shown below.

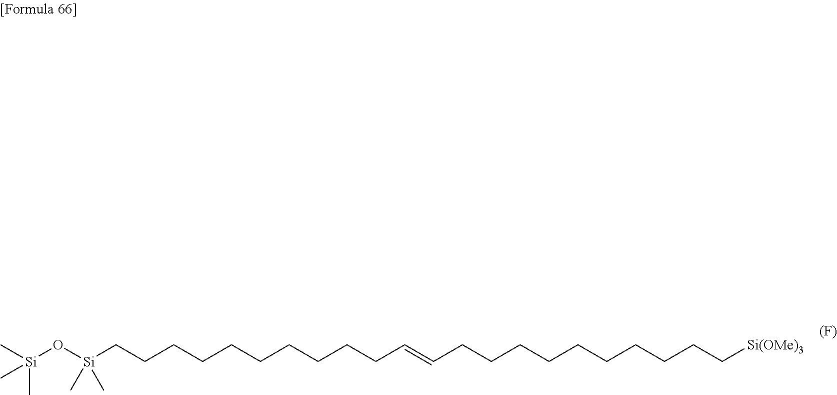

¹H-NMR (400 MHz, CDCl₃): δ5.51-5.17 (m, 2H), 3.57 (s, 9H), 2.01(D, J=5.9 Hz, 4H), 1.48-1.03 (m, 32H), 0.75-0.58 (m, 2H), 0.50 (t, J=7.4 Hz, 2H), 0.31--0.20 (m, 15H).

### Compound (Z)

A compound (Z) was synthesized with reference to Example 1 disclosed in International Patent Publication No. WO2023/017830.

Note that the compound (Z) is neither a compound represented by Formula (1-1) nor a compound represented by Formula (1-2). 17 of (SiMe₂-O—)₁₇ in the compound (Z) is an average value.

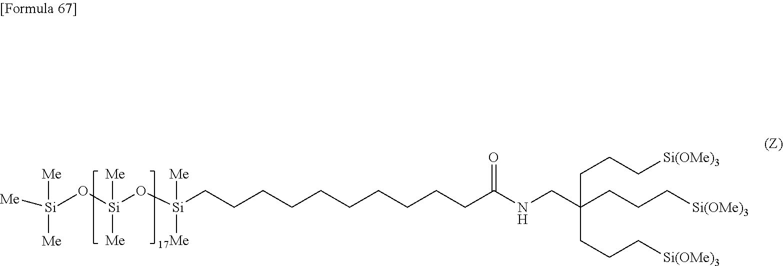

### [Manufacturing of Article]

Articles in Examples 1 to 7 were manufactured by performing surface treatments on substrates by using the above-described compounds (A), (B), (C), (D), (E), (F) and (Z), respectively. A dry coating method was used as the surface treatment method. A chemically reinforced glass was used as the substrate.

### <Dry Coating Method>

Dry coating was carried out by using a vacuum vapor-deposition apparatus (VTR-350M, manufactured by ULVAC, Inc.). For each of the compounds, 20 mass % of an ethyl acetate solution (0.5 g) of the compound was charged into a boat made of molybdenum in the vacuum vapor-deposition apparatus, and the vacuum vapor-deposition apparatus was evacuated of air so that the pressure inside the apparatus became 1×10−³ Pa or lower. The boat was heated at a temperature rising rate of 10° C./min or lower. Then, at the moment when the vapor-deposition rate measured by a quartz oscillation-type film thickness gauge exceeded 1 nm/sec, the shutter was opened and film formation (i.e., the deposition of the compound) on the surface of the substrate was thereby started. When the film thickness became about 50 nm, the shutter was closed and the film formation on the surface of the substrate was thereby finished. The substrate on which the compound was deposited was heat-treated at 200° C. for 30 minutes, and an article having a surface-treated layer on the surface of the substrate was thereby obtained.

### Evaluations

The articles obtained by the dry coating method were evaluated for water repellency and abrasion resistance. The evaluation methods were as follows.

### <Water Repellency>

Approximately 2 μL of distilled water was dropped on the surface-treated layer of the article, and the initial water contact angle was measured by using a contact angle measuring apparatus (product name: DM-500 manufactured by Kyowa Interface Science Co., Ltd). An average value of water contact angles measured at five points on the surface-treated layer was defined as the initial water contact angle for the evaluation described below. Note that a 20 method was used for the calculation of the water contact angle. The evaluation criteria were as follows. A is a level acceptable in practical use.
A: The initial water contact angle is 1050 or larger.
B: The initial water contact angle is smaller than 105°.

### <Abrasion Resistance>

A steel wool Bonstar (#0000) was reciprocated 10,000 times on the surface-treated layer of the article at a pressure of 98.07 kPa and a speed of 320 cm/min according to JIS L0849: 2013 (corresponding ISO: 105-X12: 2001) by using a reciprocating traverse tester (manufactured by KNT), and then, the water contact angle after the friction test was measured. The method for measuring the water contact angle after the friction test was similar to that for the initial water contact angle in the above-described method for evaluating water repellency. That is, an average value of water contact angles measured at five points on the surface-treated layer was defined as the water contact angle after the friction test. The abrasion resistance was evaluated based on the degree of decrease of the water contact angle due to the friction test. It can be said that the smaller the degree of decrease of the water contact angle is, the better the abrasion resistance is. The evaluation criteria were as follows. A and B are levels acceptable in practical use. Degree of decrease of water contact angle=(Initial water contact angle)−(Water contact angle after friction test)
A: The degree of decrease in the water contact angle was smaller than 1.5°
B: The degree of decrease in the water contact angle was 1.5° or larger and was smaller than 2.0°.
C: The degree of decrease in the water contact angle was 2.0° or larger and was smaller than 4.0°.
D: The degree of decrease in the water contact angle was 4.0° or larger.

Details of the compounds used in the respective examples and evaluation results thereof are shown in Table 1.

In Table 1, in Columns L¹, L², and A, corresponding groups are shown. Further, in Column “-A-(Si(R)ₙL₃₋ₙ)_{q}” groups represented by -A-(Si(R)ₙL₃₋ₙ)_{q} in Formula (1-1) are shown.

Examples 1 to 6 are examples according to the present disclosure, and Example 7 is a comparative example.

TABLE 1

| | | | | | | Evaluation | |
|---|---|---|---|---|---|---|---|
| | Compound | | | | | Water | Abrasion |
| | Type | L¹ | L² | A | —A—(Si(R)ₙL₃₋ₙ)_{q} | repellency | resistance |
| Example 1 | Compound (A) | Single bond | —CH═CH— | (g2-2) | (3-1A-4) | A | A |
| Example 2 | Compound (B) | Single bond | —C(═CH2)— | (g2-2) | (3-1A-4) | A | B |
| Example 3 | Compound (C) | Single bond | —C≡C— | (g2-6) | (3-1A-1) | A | A |
| Example 4 | Compound (D) | Single bond | —CH═CH— | (g2-6) | (3-1A-1) | A | A |
| Example 5 | Compound (E) | Single bond | —CH═CH— | (g2-6) | (3-1A-1) | B | A |
| Example 6 | Compound (F) | —(CH₂)₁₀— | —CH═CH— | (g2-6) | (3-1A-1) | A | A |
| Example 7 | Compound (Z) | | | | | A | D |

As shown in Table 1, it has been found that it is possible to form a surface-treated layer having excellent abrasion resistance with any of the compounds according to Examples 1 to 6 as compared to the compound according to Example 7.

Further, based on comparisons among Examples 1 to 6, it has been found that the abrasion resistance was more excellent when L² was —CH═CH— or —C≡C—.

A compound according to the present disclosure is useful as a surface treatment agent. Such a surface treatment agent can be used, for example, for substrates in display devices such as touch panel displays, optical elements, semiconductor elements, building materials, automobile components, and nanoimprinting technologies. Further, such a surface treatment agent can be used for bodies, window glasses (front glasses, side glasses, and rear glasses), mirrors, bumpers, and the like in transportation apparatuses such as trains, automobiles, ships, and airplanes. Further, such a surface treatment agent can be used for exterior walls of buildings, tents, photovoltaic modules, sound insulating plates, and outdoor articles such as concrete; and fishing nets, sweep nets, and water tanks. Further, such a surface treatment agent can be used for kitchens, bathrooms, washstands, mirrors, and toiletry components; chandeliers and ceramics such as tiles; and artificial marble and various indoor apparatuses such as air conditioners. Further, such a surface treatment agent can be used for antifouling treatments of jigs, inner walls, pipes, and the like in factories. Further, such a surface treatment agent can be used for goggles, glasses, helmets, pachinko, fibers, umbrellas, play equipment, and soccer balls. Further, such a surface treatment agent can be used as abherents for various packaging materials such as packaging materials for foods, packaging materials for cosmetics, and the interior of pots. Further, such a surface treatment agent can be used for car navigation systems, mobile phones, smart phones, digital cameras, digital video cameras, PDAs, portable audio players, car audios, game apparatuses, lenses for eyeglasses, camera lenses, lens filters, sunglasses, medical apparatuses such as gastroscopes, copy machines, PCs, displays (e.g., liquid crystal displays, organic EL displays, plasma displays, and touch panel displays), touch panels, protective films, and optical components such as antireflection films.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A compound represented by Formula (1-1) or Formula (1-2) 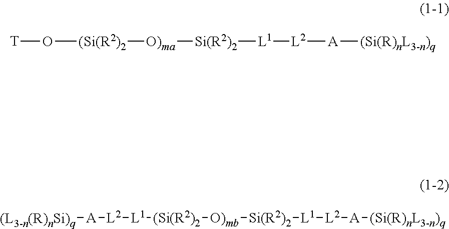
T is (R¹)₃Si—, a monovalent cyclic polysiloxane residue, or monovalent cage-like polysiloxane residue,
R¹ is each independently a hydrocarbon group or a trialkylsilyloxy group,
R² is each independently a hydrocarbon group,
L¹ is a single bond or a divalent linking group,
L² is —CH═CH—, —C≡C—, or —C(═CH₂)—,
A is a single bond or a linking group having a valence of (q+1),
R is each independently a hydrocarbon group,
L is each independently a hydrolyzable group, a group having a hydrolyzable group, or a hydroxyl group,
ma is a number of 0 or greater,
mb is a number of 1 or greater,
n is each independently an integer of 0 to 2, and
q is each independently an integer of 1 or greater.

2. The compound according to claim 1, wherein a group represented by -A-(Si(R)ₙL₃₋ₙ)q in the above-shown Formula (1-1) and the above-shown Formula (1-2) is a group represented by Formula (3-1 A) 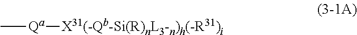
Q^{a} is a single bond or a divalent linking group,
X³¹ is a group having a single bond, an alkylene group, a nitrogen atom, a carbon atom, a silicon atom, an organopolysiloxane residue having a valence of 2 to 8, or a group having a ring having a valence of (h+i+1),
Q^{b} is a single bond or a divalent linking group,
R is each independently a hydrocarbon group,
L is each independently a hydrolyzable group, a group having a hydrolyzable group, or a hydroxyl group,
R³¹ is a hydrogen atom, a hydroxyl group, or an alkyl group,
n is an integer of 0 to 2,
when X³¹ is a single bond or an alkylene group, h is 1 and i is 0,
when X³¹ is a nitrogen atom, h is an integer of 1 to 2; i is an integer of 0 to 1; and h+i=2 is satisfied,
when X³¹ is a carbon atom or a silicon atom, h is an integer of 1 to 3; i is an integer of 0 to 2; and h+i=3 is satisfied,
when X³¹ is an organopolysiloxane residue having a valence of 2 to 8, h is an integer of 1 to 7; i is an integer of 0 to 6; and h+i=1 to 7 is satisfied, and
when X³¹ is a group having a ring having a valence of (h+i+1), h is an integer of 1 to 7; i is an integer of 0 to 6; and h+i=1 to 7 is satisfied.

3. The compound according to claim 1, wherein L¹ is a single bond or an alkylene group.

4. The compound according to claim 1, wherein L¹ is a single bond.

5. The compound according to claim 1, wherein ma and mb are each independently a number of 2 to 600.

6. The compound according to claim 1, wherein q is an integer of 1 to 4.

7. A composition comprising the compound according to claim 1, and a liquid medium.

8. A surface treatment agent comprising the compound according to claim 1.

9. A surface treatment agent comprising the compound according to claim 1, and a liquid medium.

10. A method for manufacturing an article including a surface-treated layer formed on a substrate by performing a surface treatment on the substrate by using the surface treatment agent according to claim 8.

11. An article comprising a substrate, and a surface-treated layer disposed on the substrate, a surface of the surface-treated layer being treated with the surface treatment agent according to claim 8.

12. The article according to claim 11, wherein the article is an optical member.

13. The article according to claim 11, wherein the article is a display or a touch panel.

14. A method for manufacturing an article including a surface-treated layer formed on a substrate by performing a surface treatment on the substrate by using the surface treatment agent according to claim 9.

15. An article comprising a substrate, and a surface-treated layer disposed on the substrate, a surface of the surface-treated layer being treated with the surface treatment agent according to claim 9.

16. The article according to claim 15, wherein the article is an optical member.

17. The article according to claim 15, wherein the article is a display or a touch panel.
